(19) United States
(12) Patent Application Publication
(10) Pub. No.: US 2018/0082260 A1
(43) Pub. Date: Mar. 22, 2018

(54) COMPUTER SYSTEM AND METHOD FOR PROVIDING ADVANCED SCHEDULING WITH INTEGRATED SOCIAL AND REVERSE AUCTION COMPONENTS

(71) Applicant: 4Thought Studios LLC, Detroit, MI (US)

(72) Inventors: Bradley William Dunn, Royal Oak, MI (US); Kwame Kamau Beard, Detroit, MI (US); Jenna Hussein Hage-Hassan, Livonia, MI (US); Khalil Ibrahim Khalaf, Dearborn, MI (US)

(21) Appl. No.: 15/708,773

(22) Filed: Sep. 19, 2017

Related U.S. Application Data
(60) Provisional application No. 62/503,214, filed on May 8, 2017.
(60) Provisional application No. 62/397,502, filed on Sep. 21, 2016.

(51) Int. Cl. G06Q 10/10; G06Q 30/02

(52) U.S. Cl. CPC G06Q 10/1093; G06Q 30/0267; G06Q 30/0261

(57) ABSTRACT

A computer system comprising of a database that includes a plurality of sales campaign data records and a plurality of user records; and an application server programmed to: select a sales campaign from the plurality of sales campaigns and initiate the sales campaign, including: determine a campaign time period, a service time, and a vendor location associated with the sales campaign; identify consumers associated with the sales campaign including: identify user records having free time slots that are within the current campaign time period; determine a current location of a mobile computing device associated with the identified user record; determine a first travel time; determine a second travel time; determine a total event time period; generate a set of qualified consumers having a determined total event time period within a corresponding free time slot; and transmit a notification including a promotion to each mobile computing device.

### CROSS-REFERENCE TO RELATED APPLICATION

This application claims priority to U.S. Provisional Patent Application Ser. No. 62/503,214, filed May 8, 2017, and to U.S. Provisional Patent Application Ser. No. 62/397,502, filed Sep. 21, 2016, both of which are hereby incorporated by reference in their entirety.

### BACKGROUND OF THE INVENTION

### 1. Field of the Invention

This invention generally relates to mobile phone users and a mobile phone application. More specifically, the present invention relates to a system, a method, and a non-transitory computer-readable storage media related to mobile phone users.

### 2. Description of the Related Art

At least some known computer systems allow users to maintain information related to a user's calendar schedule on a mobile device, such as a smartphone. In addition, known systems allow users to download and install mobile software applications on the mobile devices that allow users to receive notifications from retail and restaurant operators via the mobile devices. However, past attempts to integrate these applications have left users with a frustrating experience, in part, because the notifications are untimely and not relevant to the user's activity at the time the notifications are sent. For example, currently, users use separate mobile applications for time management, mapping and GPS, social media, and commerce.

In addition, the computing resources required to manage the data information associated with user calendar schedules and retailer notifications becomes significant as the number of users and retail operators use the system.

Accordingly, there is a need for a computer system that efficiently manages the data received from mobile devices in order to provide users with timely and relevant notifications, and reduces the amount of data required to generate and transmit these notifications.

The present invention is aimed at one or more of the problems identified above.

### SUMMARY OF THE INVENTION

In one embodiment, a computer system comprises of a database and an application server. The database includes a plurality of sales campaign data records and a plurality of user records. Each sales campaign data record is associated with a retail product offering and includes a unique vendor ID associated with a vendor, address data, and promotion data. The address data indicates a physical location of the vendor, and the promotion data includes a campaign time period, a service time, and product offering information. The campaign time period includes a period of time during which the retail product offering is available to consumers and the service time includes an amount of time required to provide the retail product offering to a consumer. In addition, each user record includes a unique user ID associated with a corresponding consumer, a mobile ID associated with a mobile computing device, and data associated with a plurality of calendar events. Each calendar event includes a calendar time period and location, and the plurality of calendar events include a first appointment event, a second appointment event, and a free time slot between the first appointment and the second appointment. The application server includes a processor that is programmed to select a current sales campaign from the plurality of sales campaigns and initiate the current sales campaign. In addition, the application server determines a current campaign time period, a current service time, and a current vendor location associated with the current sales campaign and identifies qualified consumers associated with the selected current sales campaign. The application server then identifies user records having free time slots that are within the current campaign time period, and for each identified user record determines a current location of a mobile computing device associated with the identified user record. In addition, the application server determines a first travel time from the current location to the current vendor location and determines a second travel time from the current vendor location to the second appointment event. The application server determines a total event time period equal to the first travel time, the second travel time, and the service time; and generates a set of qualified consumers including each identified user record having a determined total event time period within a corresponding free time slot. Then the application server transmits a notification including a first promotion including product offering information associated with the selected sales campaign to each mobile computing device associated with each qualified consumer.

In another embodiment, a method of operating a computer system includes accessing a database that includes a plurality of sales campaign data records. Each sales campaign data record is associated with a retail product offering and includes a unique vendor ID associated with a vendor, address data, and promotion data. The address data indicates a physical location of the vendor, and the promotion data includes a campaign time period, a service time, and product offering information. The campaign time period includes a period of time during which the retail product offering is available to consumers and the service time includes an amount of time required to provide the retail product offering to a consumer. In addition, the method selects a current sales campaign from the plurality of sales campaigns and initiates the current sales campaign. The method determines a current campaign time period, a current service time, and a current vendor location associated with the current sales campaign and identifies qualified consumers associated with the selected current sales campaign. The method then accesses the database that includes a plurality of user records. Each user record includes a unique user ID associated with a corresponding consumer, a mobile ID associated with a mobile computing device, and data associated with a plurality of calendar events. Each calendar event includes a calendar time period and location, and the plurality of calendar events include a first appointment event, a second appointment event, and a free time slot between the first appointment and the second appointment. In addition, the method identifies user records having free time slots that are within the current campaign time period and determines a current location of a mobile computing device associated with the identified user record. The method determines a first travel time from the current location to the current vendor location and determines a second travel time from the current vendor location to the second appointment event. In addition, the method determines a total event time period equal to the first travel time, the second travel time, and the service time and generates a set of qualified consumers including each identified user record having a determined total event time period within a corresponding free time slot. The method transmits a notification including a first promotion including product offering information associated with the selected sales campaign to each mobile computing device associated with each qualified consumer.

In yet another embodiment, one or more non-transitory computer-readable storage media, having computer executable instructions embodied thereon are provided. When executed by at least one processor, the computer-executable instructions cause the processor to access a database including a plurality of sales campaign data records and a plurality of user records. Each sales campaign data record is associated with a retail product offering and includes a unique vendor ID associated with a vendor, address data, and promotion data. The address data indicates a physical location of the vendor, and the promotion data includes a campaign time period, a service time, and product offering information. The campaign time period includes a period of time during which the retail product offering is available to consumers and the service time includes an amount of time required to provide the retail product offering to a consumer. In addition, each user record includes a unique user ID associated with a corresponding consumer, a mobile ID associated with a mobile computing device, and data associated with a plurality of calendar events. Each calendar event includes a calendar time period and location, and the plurality of calendar events include a first appointment event, a second appointment event, and a free time slot between the first appointment and the second appointment. The processor includes a processor that is programmed to select a current sales campaign from the plurality of sales campaigns and initiate the current sales campaign. In addition, the processor determines a current campaign time period, a current service time, and a current vendor location associated with the current sales campaign and identifies qualified consumers associated with the selected current sales campaign. The processor then identifies user records having free time slots that are within the current campaign time period and, for each identified user record determines a current location of a mobile computing device associated with the identified user record. In addition, the processor determines a first travel time from the current location to the current vendor location and determines a second travel time from the current vendor location to the second appointment event. The processor determines a total event time period equal to the first travel time, the second travel time, and the service time; and generates a set of qualified consumers including each identified user record having a determined total event time period within a corresponding free time slot. The processor transmits a notification including a first promotion including product offering information associated with the selected sales campaign to each mobile computing device associated with each qualified consumer.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present invention;

FIG. 2 is a schematic illustrating example components of a server computer that may be used with the system shown in FIG. 1, according to an embodiment of the present invention;

FIGS. 3-5 are flowcharts of methods that may be used with the system shown in FIG. 1, according to embodiments of the present invention;

FIGS. 6-10 are illustrations of exemplary database records generated by the system of FIG. 1, according to embodiments of the present invention;

FIGS. 11-32 are illustrations of exemplary screenshots from the system of FIG. 1, according to an embodiment of the present invention;

FIGS. 33-41 are flowcharts of methods that may be used with the system shown in FIG. 1, according to embodiments of the present invention;

FIG. 42 is another schematic illustrating components of the system shown in FIG. 1, according to an embodiment of the invention; and

FIG. 43 is a schematic illustrating components of a component board that may be used with the system shown in FIG. 1, according to an embodiment of the invention.

Corresponding reference characters indicate corresponding components throughout the several views of the drawings.

### DETAILED DESCRIPTION OF THE INVENTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, a reasonable programmable read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

In general, the present invention includes a networked computer system 10 that is configured to generate information related to user calendar schedules and current location data of a user's mobile device to allow retail operators to generate and transmit relevant notifications to the user's mobile devices. The networked computer system includes application software that enables the system to provide a platform for local businesses to market to potential customers based on the consumer's schedule, likes and dislikes, and daily schedule and habits.

The system application software provides business owners with a platform to offer personalized deals and specials and allow consumers to control and further personalize the interaction. This functionality utilizes the social aspects of a scheduling application, along with other social media accounts and optional-in application profile preferences to provide insight for more targeted offerings. The application software allows the business owner to increase traffic, sales, and customer base, while providing the consumer with better prices and an overall better shopping experience. The application software includes two program versions: a user version available in all the application stores and potentially pre-installed as a part of default carrier software loads (for example: AT&T, Sprint, Verizon, etc.); and a privately distributed business owner or vendor version with admin, owner, and employee level access that will provide the functionality to be described below. Several elements discussed below and/or claimed are described as being provided for, or, by “a user”, “a consumer”, or “a vendor” and may be interchangeable throughout and described below.

In addition, the networked computer system provides a reverse auction function to consumer users via mobile computing devices, and provides notifications of promotions to the consumer via a push notifications transmitted to the mobile computing devices and/or a mobile website when the consumer's mobile device is within the general proximity to a vendor location with a sales campaign and the consumer's schedule has available free time that is within the sales campaign promotional time period. Moreover, the networked computer system communicates with a mobile device associated with the consumer to provide notifications to the mobile devices including messages about potential promotions to the user. In addition, the system 10 may determine the location of the consumer's mobile device using an external server based on the geographic location of the corresponding mobile device that may affect or require the use of an internal server to re-calculate the user's available free time after the user accepts the promotion. The external server may use location actions which may return information about the consumer's mobile device location, including information related to the consumer's current location by pinging the GPS locator in the consumer's mobile device. The external server may communicate with the 3rd party computer server to ping the consumer's location. By using the reactive re-scheduling event, the free time management event and the predictive scheduling event, the internal server may manage the consumer's calendar including re-scheduling the consumer's schedule if, for example, a traffic accident were to occur on the consumer's way to the vendor location. In addition, the internal server may include the free time management event which may manage the consumer's free time by suggesting activities to fill the free time slot and the predictive scheduling event which may predict specific traffic patterns and suggest changes to the consumer's schedule. The system 10 determines through the application server the action events and triggering events between the internal server and the external server. The system 10 may then transmit push notifications to the user with information about current active sales campaigns in the user's proximity. The system 10 may also include a mobile computer application being stored on a mobile device associated with the user. The mobile application uses location and public API's to send active sales campaigns to the consumer. For example, in one embodiment, the consumer receives a sales campaign notification during the consumer's lunch hour for a special on lunch. The system 10 may also identify additional consumers such as, for example, family, friends, and vendors, to receive similar notifications to provide the additional users with the information associated with the consumer and/or with the active sales campaign.

The system 10 is configured to generate and store user data records associated with consumers that include information associated with a user calendar (also known as schedule) and free time available. The system 10 also determines action events that are associated with the consumer's free time and generates and stores action records that includes information associated with actions to be performed by the system 10 upon detecting activities being performed by the user. For example, the action events may include initiating data search operations, task optimization actions, reactive reschedule actions, free time management actions, predictive scheduling actions, location actions, business/place actions, and traffic actions in order to search for active sales campaigns, to search for users with similar free time slots as the active sales campaigns, to determine the user's total time, and/or provide notifications to the user via the user's mobile device.

In addition, the user data records may include triggering events that are detected by the system 10 to initiate the action events. The triggering events may include, for example, an accident on the way to the user's next appointment, requests received by the user to fill the free time with a task, the user preferences or mood, and/or accepting a promotion from a vendor.

By generating action event records associated with user activities that include triggering events that trigger corresponding system actions, the system 10 improves the speed and functionality of known computing systems by reducing the amount of computing time required to monitor user activity, thus reducing the computing resources required to generate and display relevant data messages from multiple programs to the user.

In addition, the system reduces the computing resources required to manage the data information associated with user calendar schedules and retailer notifications over known systems by generating data files associated with user profiles and vendor profiles that can be quickly searched based on current GPS location data to generate targeted messaging using limited computing resources.

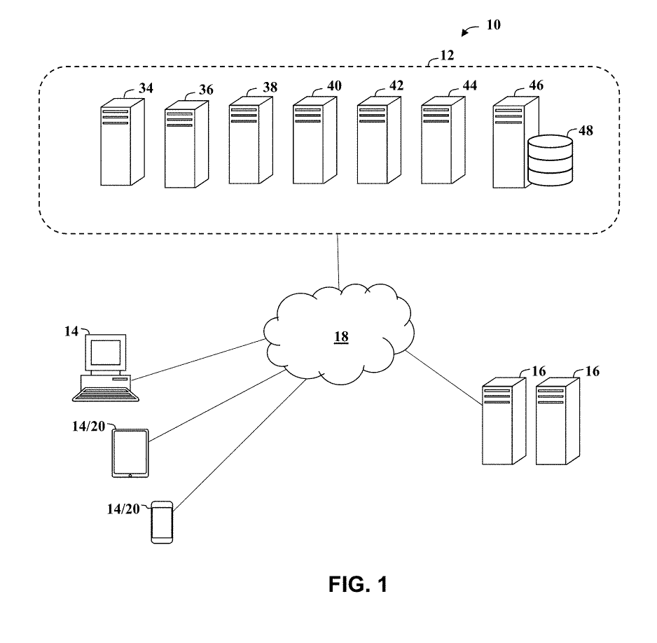

Referring to FIG. 1, in the illustrated embodiment, the system 10 includes a server system 12 that is coupled in communication with one or more user computing devices 14 and one or more 3^{rd} party computer servers 16 via a communications network 18. The communications network 18 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 14 may include any suitable device that enables the user to access and communicate with the system 10 including sending and/or receiving information to and from the system 10 and displaying information received from the system 10 to the user. For example, in one embodiment, the user computing device 14 may include, but is not limited to, a desktop computer, a laptop or notebook computer, a tablet computer, a smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

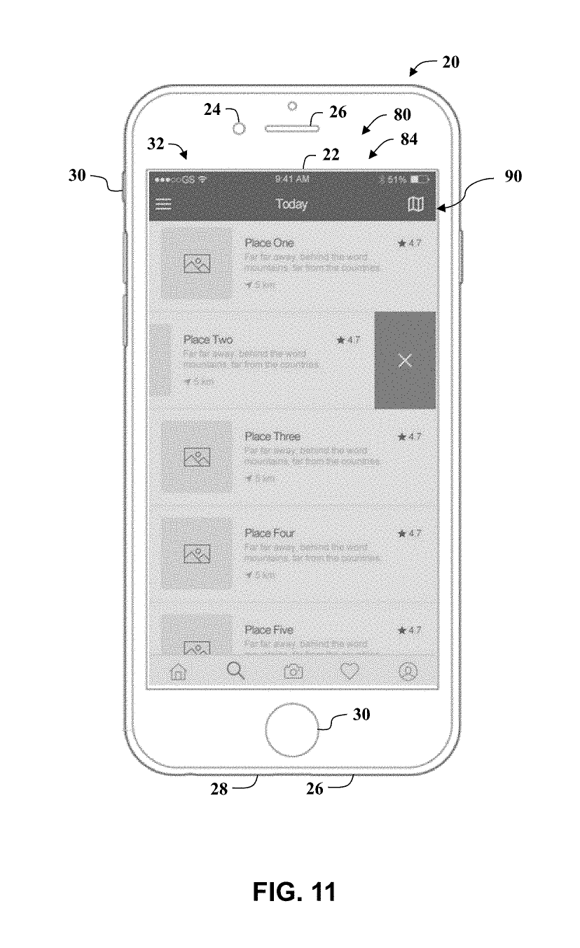

In one embodiment, the user computing device 14 includes a mobile computing device 20 (shown in FIG. 11) such as, for example, a smartphone such as an iPhone™. The mobile computing device 20 includes a processor coupled to a memory device, and a database for storing various programs and data for use in operating the mobile computing device 20. The mobile computing device 20 may also include a touchscreen display device 22, one or more video image cameras 24, one or more speakers 26, a microphone 28, at least one input button 30, and one or more sensors including, but not limited to, a touch ID fingerprint sensor coupled to an input button 30, a barometer, a three-axis gyro, an accelerometer, proximity sensor, and an ambient light sensor. In addition, the mobile computing device 20 may also include a Wi-Fi antenna, a cellular network antenna, a Bluethooth′ communications device, assisted GPS and GLONASS, a digital compass, and an iBeacon microlocation device.

In the illustrated embodiment, the mobile computing device 20 includes a web browser programmed and stored in the memory device. The processor executes the web browser program to display web pages on the touchscreen display device 22 that includes information received from the server system 12 to enable the user to interact with and operate the server system 12. In addition, the mobile computing device 20 may be programmed to store and execute a mobile program application, e.g., a mobile application, that displays a user interface 32 (shown in FIG. 11) on the touch screen display device 22 that allows the user to access the server system 12 to retrieve and store information within the server system 12 as well as interact with and operate the server system 12. In addition, in one embodiment, the system 10 may install one or more mobile application programs in the memory device of the mobile computing device 20. When initiated by the processor of the mobile computing device 20, the mobile application program causes the processor of the mobile computing device 20 to perform some or all of the functions of the server system 12.

The 3^{rd} party computer servers 16 include information and data associated with street or map conditions associated with various locations. For example, in one embodiment, the 3^{rd} party computer servers 16 may include information associated with traffic conditions for various geographical locations. The environmental information may include, for example, traffic, accidents, routes to vendor locations, and/or any suitable environmental information associated with geographic locations. In addition, the environmental information may include historic traffic conditions to help plan ahead for traffic conditions at a specific time.

In the illustrated embodiment, the server system 12 includes a website hosting server 34, a sales campaign broker server 36, a search engine server 38, an application server 40, an external server 42, an internal server 44, a database server 46 and a database 48. The database server 46 includes a memory device that is connected to the database 48 to retrieve and store information contained in the database 48. The database 48 contains information on a variety of matters, such as, for example, web pages associated with one or more websites, a list of sales campaign data, vendor IDs, vendor locations, campaign times, service times, data associated with promotions, user records, calendar data, action events, trigger events, notification messages, mobile device identifiers, mobile device application program interfaces (APIs), and/or any suitable information that enables the system 10 to function as described herein. In one embodiment, some or all of the information contained in the database 48 may also be stored in the database of the mobile computing device 20.

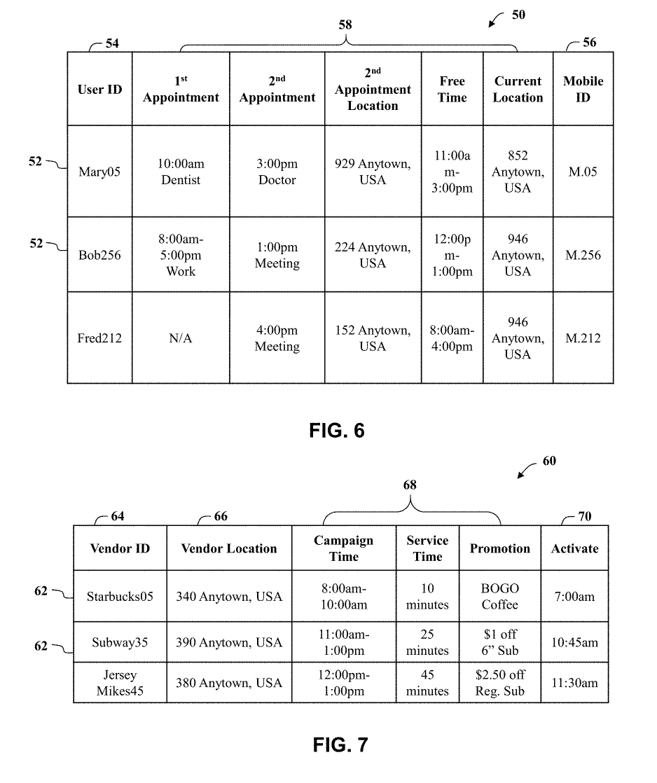

In the illustrated embodiment, the database 48 includes a user records list 50 (shown in FIG. 6) that includes a plurality of user records 52. Each user record 52 includes a unique user ID 54 associated with a corresponding consumer, a mobile ID 56 associated with a mobile computing device, data associated with a plurality of calendar events 58, where each calendar event includes a calendar time period and a location, and the plurality of calendar events include a plurality of consumer tasks, a first appointment event, a second appointment event, and a free time slot between the first appointment and the second appointment. The unique user ID 54 includes user identifying data such as, for example, a unique ID and/or password; and may also include user contact information such as, for example, a phone number, an email, and/or a mobile device data associated with a mobile computing device 20 associated with the user. For example, the mobile device data may include, but is not limited to, the unique mobile device ID 56, operating system, phone number, IP address, mobile device API, and/or any suitable information that enables the system 10 to communicate with the corresponding mobile computing device 20. The data associated with the plurality of calendar events 58 includes information associated with a corresponding user calendar such as, for example, the plurality of consumer tasks, the first appointment event, the second appointment event, and the free time slot between the first appointment and the second appointment.

In one embodiment, the database 48 also includes a sales campaign list 60 (shown in FIG. 7) that includes a plurality of sales campaign data records 62. Each sales campaign data record 62 (also known as a sales campaign) is associated with consumer products and/or services being offered by a retail vendor. The sales campaign data record 62 includes a unique vendor ID 64 associated with a vendor, address data 66 indicating a physical location of the vendor, and promotion data 68 including a campaign time period, a service time, and product offering information. The campaign time period includes a period of time during which the retail product offering is available to consumers and the service time includes an amount of time required to provide the retail product offering to a consumer. Each promotion is associated with corresponding actions events 70 and/or operations that may be initiated by the system 10, for example becoming active at a specific time. In addition, for example, types of promotions may include but are not limited to, limited sale offerings, service offerings, product discounts, etc. Promotions are sent from the vendor to the consumer in order for the consumer to visit the vendor location and purchase the services at the vendor location.

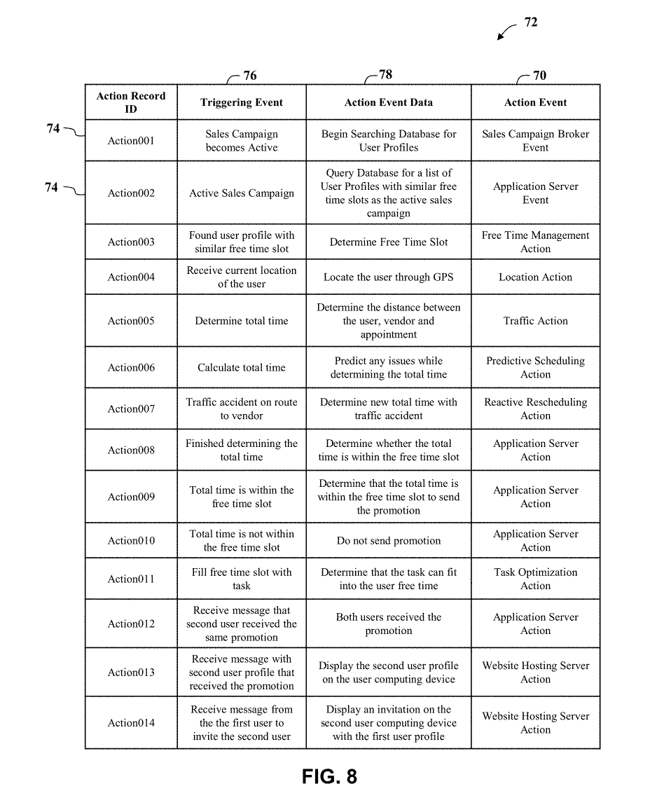

In one embodiment, the database 48 may also include an action event record list 72 (shown in FIG. 8) that includes a plurality of action event records 74. Each action event record 74 may include a triggering event 76, action event data 78, and the action event 70. The system 10 may initiate the action event 70 once the action event is triggered by the triggering event 76. By the action event 70 being triggered by the triggering event 76, the action event 70 may then send the action event data 78 to the corresponding server, dependent on which action event has been triggered. Action event data 78 includes information and data including, but is not limited to, determining free time slots, determining total times, and/or determining whether the total time may fit within the free time slot. As shown in FIG. 8, the action event data description may include data associated with the corresponding action record. For example, in one embodiment, the action event data, Action005, includes information that enables the system 10 to initiate calculating of the total time of the consumer with a free time slot within the campaign time period. The triggering event data includes data associated with the triggering event 76 that includes an event or occurrence that may be detected by the system 10. The triggering events 76 may include, but are not limited to, requests and/or signals received by the user computing device 14, for example, a change in traffic, modifications to a consumer's schedule, a task added to the user calendar information 58, and/or any suitable triggering event that enables the system 10 to perform as described herein. Once the system 10 initiates the triggering event 76 the triggering event 76 triggers the corresponding action event 70, which will send the action event data 78 to the corresponding server.

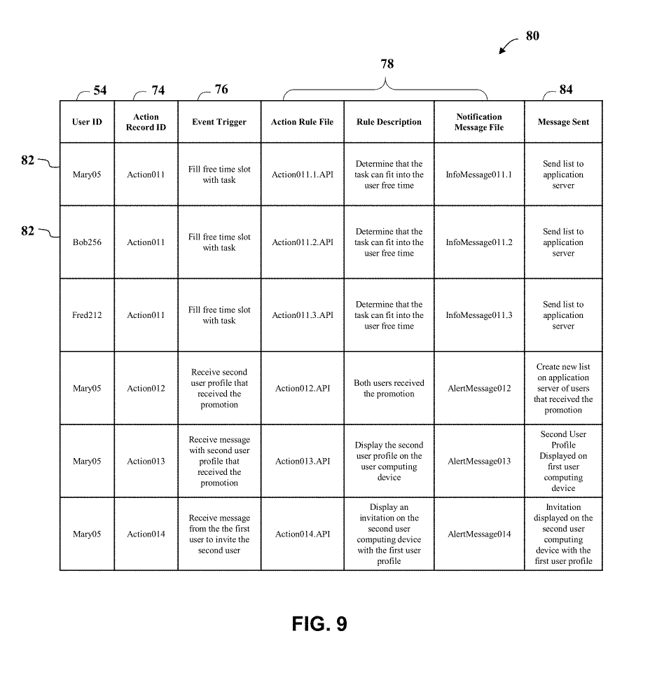

The database 48 may also include a user action record list 80 (shown in FIG. 9) that includes a plurality of user action records 82 that are associated with a plurality of users. Each user action record 82 includes the user record 52 associated with the corresponding user ID 54, the action record ID 74, the triggering event 76 and action event data 78. In addition, the user action record 82 may also include messaging information 84 including data and information to be sent with a mobile computing device 20 associated with the corresponding user profile 54 and/or API information associated with the corresponding mobile computing device 20. In one embodiment, the messaging information 84 may also include contact information such as, for example, emails, and/or text and phone numbers, associated with friends, relatives, and/or vendor preferences associated with previous visits to a vendor location. The application server 40 may identify one or more additional users that may receive notifications generated by the website hosting server 34 and include contact information associated with the identified additional users in the messaging information 84 that has received a promotion from the same vendor.

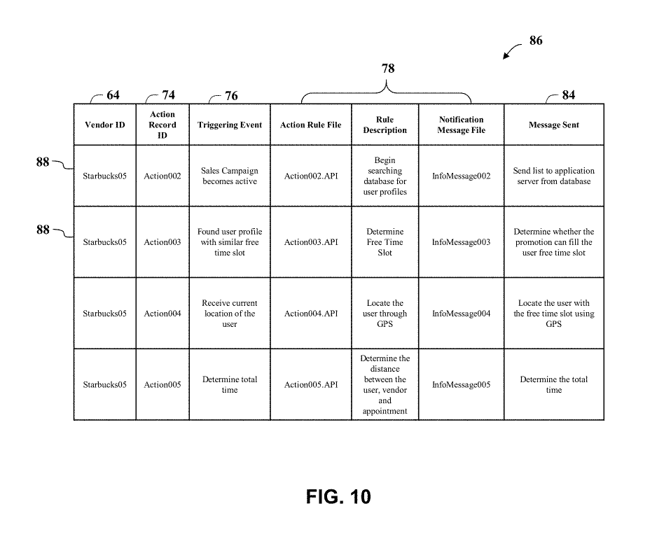

In one embodiment, the database 48 may include a vendor action list 86 (shown in FIG. 10) that includes a plurality of vendor action records 88. Each vendor action record 88 includes vendor information 64 including the vendor ID that is associated with a sales campaign data record 62, (shown in FIG. 7) the action record ID 74 that performs the actions of the sales campaign 62, the triggering event 76 that triggers the actions of the sales campaign 62, the action event data 78 that is sent to the corresponding server, and message information 84. For example, the vendor action record, with vendor ID “Starbucks05”, may include the process that corresponds with Action001 (shown in FIG. 10), where the triggering event 76 is when the sales campaign 62 becomes active for example at 7:00 am, which triggers the action event 74 sending the action event data 78 from the sales campaign broker server 36 to the application server 40 in order to begin searching the database 48 for user profiles 54 with free time slots within the campaign time period.

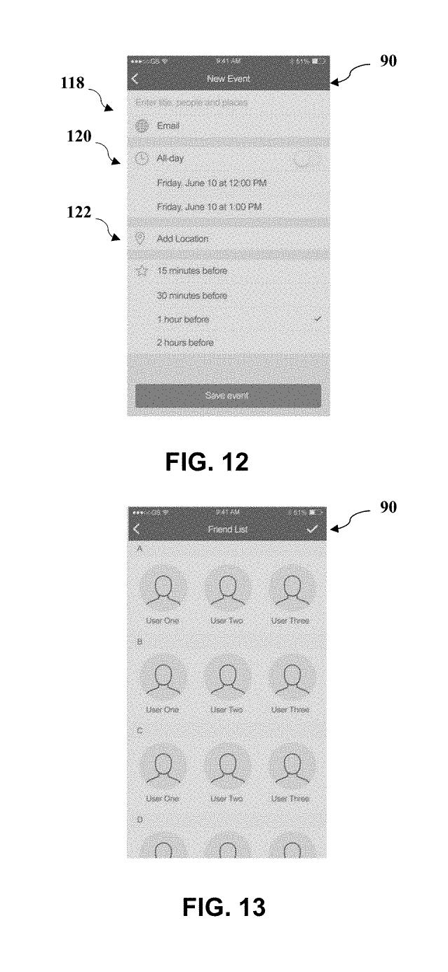

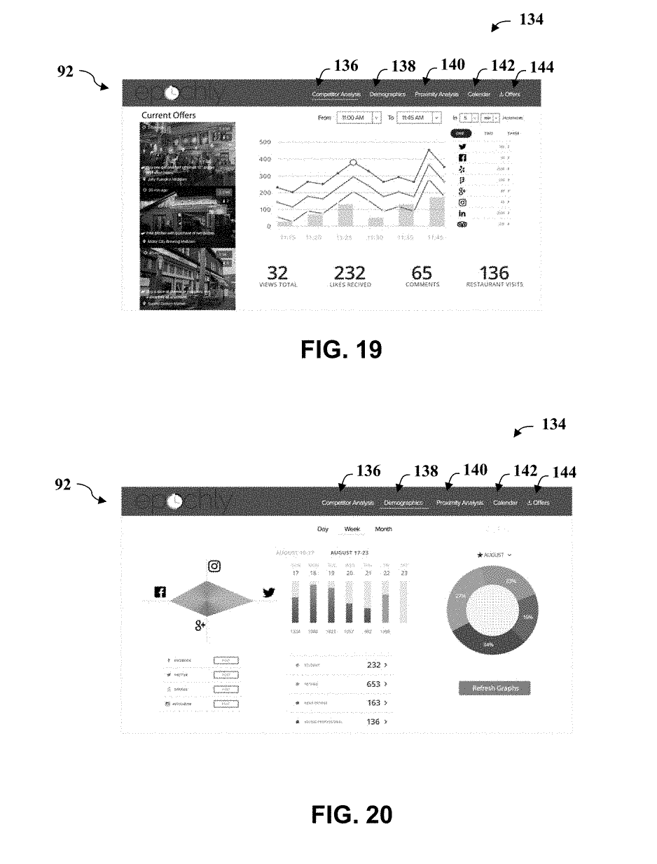

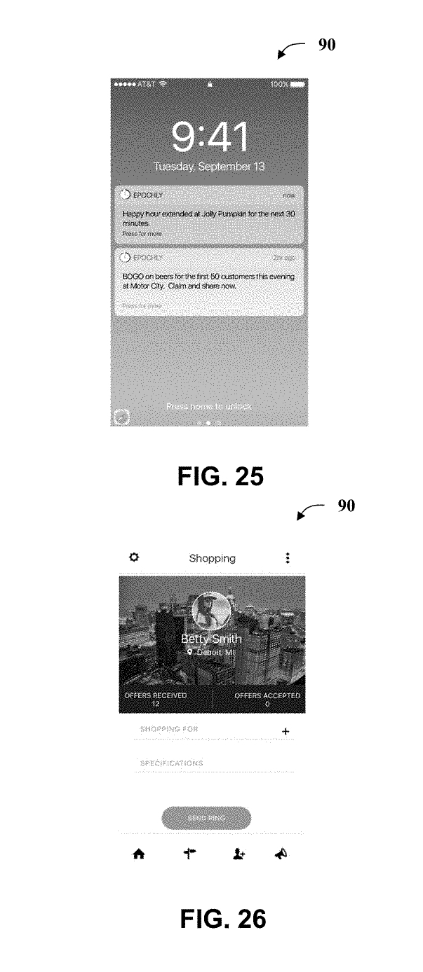

The website hosting server 34 is configured to host a website that is accessible by the user via one or more user computing devices 14. The website hosting server 34 retrieves and stores web pages 90 (illustrated in FIGS. 11-32) associated with one or more websites in response to requests received by the consumer via the user computing device 14 to allow consumers to interact with the website and search and/or accept and/or decline promotions such as, for example, a promotion for a free coffee with a bagel purchase via the website. In one embodiment, the website hosting server 34 is configured to generate and display vendor web pages 92 (shown in FIGS. 19-23) associated with the website in response to requests being received from consumers via corresponding web browsers that are displayed on the user computing devices 14. In addition, the website hosting server 34 may be configured to generate and display a mobile web page, the mobile web page can be either the consumer web page 90 or the vendor web page 92, (shown in FIGS. 11-32) that is displayed on one or more mobile computing devices 20. For example, in one embodiment, the website hosting server 34 may display (shown in FIG. 18) a map with the route and calculation of the current traffic from the user current location from the mobile ID 56 to the vendor location 66 and from the vendor location to the user's second appointment location (not shown). In addition, the website hosting server 34 may display (shown in FIGS. 19-23) the vendor web page 92, which may display competitor data, demographics of the consumers, consumers within a predetermined proximity to the vendor location, calendar of scheduling of sales campaigns and/or a preview of how the promotion of the sales campaign may look on the user computing device of the consumers.

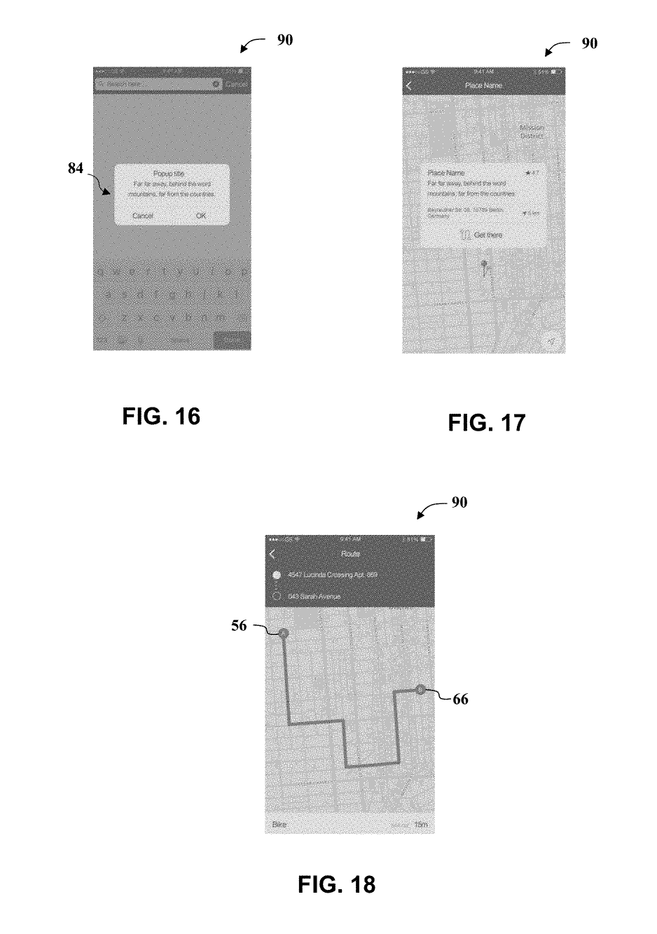

In one embodiment, the website hosting server 34 may allow consumers and vendors to login and access corresponding consumer profile accounts 54 (user ID) and corresponding vendor profile accounts 64 (vendor ID), including account information such as, for example, active and inactive sales campaigns, calendar data 58, task lists, and/or other consumer or vendors using the website via the user computing device 14. For example, the website hosting server 34 may display a login page, receive a unique consumer ID such as, for example, a username and/or password, and identify the consumer account associated with the unique consumer ID 54 to enable the identified consumer to access information and/or features associated with the corresponding user profile account. In addition, shown in FIG. 16, the website hosting server 34 may transmit search requests to the search engine server 38 and/or the application server 40 for use in generating search data and/or vendor search information in response to the consumer's search request. For example, the consumer may be in the mood for sushi, and the consumer may, through the website hosting server 34, search for vendors within a predefined proximity to the consumer's current location that have current promotions for sushi. The website hosting server 34 may also receive one or more requests from the search engine server 38 and/or the application server 40 that includes requests for information associated with the sales campaign 62, which is selected based on the consumer's search criteria, for example, a vendor with a promotion on sushi within a predefined proximity to the consumer's current location. The website hosting server 34 may also display a search results webpage to display the sales campaign lists 60 to the consumer and to allow the consumer to select one or more of the displayed promotions for choosing (shown in FIGS. 17, 25, and 30).

In another embodiment, the website hosting server 34 is configured to display real-time data on the location/proximity of consumers from the external server 42. After receiving the real-time data from the external server 42, the website hosting server 34 provides a map view as well as a list view to visualize the available consumers to the vendor (shown in FIG. 20). Moreover, the vendor may only receive consumers that have a current location within a predefined proximity to the vendor location. The vendor may set the predefined proximity in the sales campaign broker server 36 when creating the sales campaign or entering the sales campaign data record 62.

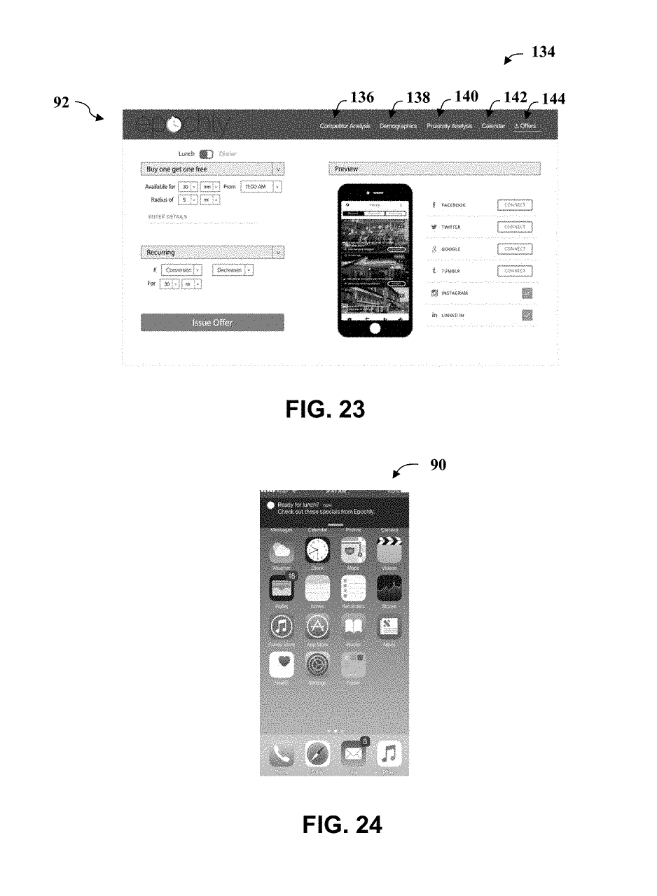

The sales campaign broker server 36 is configured to generate and store the sales campaign 62 that is accessible by the vendor via one or more user computing devices 14. In addition, the sales campaign broker server 36 may be programmed to transmit signals indicating active and inactive sales campaigns to the application server 40. The sales campaign broker server 36 generates and stores sales campaigns 62 (shown in FIGS. 22 and 23) associated with one or more vendor IDs 64 in response to requests received by the vendor via the user computing device 14 to allow vendors to interact with the sales campaign 62 and set-up the sales campaign 62 such as, for example, the vendor creates a sales campaign with a promotion that may run from 12:00 noon until 1:00 p.m. for all users within a 5 mile radius of the vendor location. In one embodiment, the sales campaign broker server 36 is configured to generate and display sales campaigns 62 associated with the vendor in response to requests being received from consumers via corresponding web browsers that are displayed on-the user computing device 14.

In addition, the sales campaign broker server 36 is configured to determine whether the sales campaign 60 is an active or an inactive sales campaign. The active sales campaign is a sales campaign that is currently being initiated by the application server 40. The inactive sales campaign is being stored on the sales campaign broker server 36 waiting for the campaign time to be activated. The inactive sales campaign becomes active when the triggering event 76 triggers the activation of the sales campaign, which will send the activated sales campaign to the application server to initiate the sales campaign. Referring to FIG. 8, in Action001, the sales campaign 62 becomes active which triggers the sales campaign broker event which sends a request to the application server 40 to begin searching the database 48. The application server 40 is programmed to periodically update the set of qualified consumers during the current campaign time period of the active sales campaign. In one embodiment, the application server 40 is configured to distribute notifications or promotions of the active sales campaigns from the sales campaign broker server 36 such as, for example, custom limited-time announcements that group together one or more discounts, new and/or improved inventory, daily specials and other custom messages to be sent to users.

In another embodiment, the sales campaign broker server 36 is configured to send a message to the application server 40 to access the database 48 and retrieve a sales campaign 62 from the list of sales campaigns 60 where the sales campaign is created to generate a list of similar consumer profiles immediately. The vendor may create a sales campaign that may begin querying consumer profiles 56 as soon as the vendor hits save on the user computing device 14 allowing the system 10 to begin immediately initiating the sales campaign 62. In addition, the sales campaign may be previously made (also known as a pre-made sales campaign) and stored on the database 48 to be initiated at a later time. Once the sales campaign time becomes active, the sales campaign broker server 36 may be triggered to send the now active sales campaign to the application server 40 to initiate the sales campaign.

In the illustrated embodiment, the search engine server 38 is configured to receive a search request from the website hosting server 34 and/or the application server 40 including one or more search terms, and generate search data including a plurality of records as a function of the search terms. For example, in one embodiment, the search engine server 38 may initiate a search algorithm based on a Boolean model to search user records 52 and/or search terms contained in the sales campaign list 60 contained in the database 48 based on search terms received from the consumer through the web site hosting server 34 and/or received from the application server 40. For example, the consumer may want a coffee and may search for any active sales campaigns including promotions for coffee within the user's proximity and that may have a current campaign time period during the consumer's free time slot. In addition, the search engine server 38 may send a request to the application server 40 to generate search data including user records 52 having free time slots that are within the current campaign time period, user records 52 having a free time slot where the total time is within the total event time, and/or users that receive promotions from the same vendor with free time slots within the campaign time period.

In the illustrated embodiment, the application server 40 is programmed to monitor activities associated with sales campaign promotions being sent to user computing devices 14. For example, in one embodiment, the application server 40 is configured to monitor user profiles 54 that accept promotions and user profiles 54 that decline promotions sent during active sales campaigns by the sales campaign broker server 36. In addition, the application server 40 is programmed to detect the occurrence of triggering events 76 associated with active sales campaigns being sent by the sales campaign broker server 36 and transmit promotion messages 84 to the user computing device 14 to provide information and notifications of the sales campaign promotion. In addition, the application server 40 may also be programmed to monitor information associated with the external server 42 including geographic locations of the user for use in generating traffic routes, alternative traffic routes, and messages that include traffic changes, whether the user is going to be late to the next appointment or not, and/or any other notification messages that are described herein. The application server 40 may also be programmed to receive updates to consumer schedules associated with the internal server 44 for use in determining whether the user fills free time with a task, a reactive rescheduling of the user's schedule, managing the user free time slots, and determine predictive scheduling issues.

In the illustrated embodiment, the application server 40 is programmed to access the database 48 including a plurality of sales campaign data records 62 and a plurality of user records 50. In addition, the application server 40 is configured to select a current sales campaign from the plurality of sales campaigns and initiate the current sales campaign. The application server 40 may determine a current campaign time period, a current service time, and a current vendor location associated with the current sales campaign. The application server 40 is configured to then identify qualified consumers associated with the selected current sales campaign. In order to identify qualified consumers the application server 40 is configured to identify user records 50 that have free time slots that are within the current campaign time period and, for each identified user record, the application server 40 may determine a current location of the mobile computing device 20 associated with the identified user record 52. The application server may send a request or triggering event 76 to the external server 42 triggering an action event from the external server 42 to retrieve the current location of the user from the 3^{rd} party computer server 16 using GPS in the mobile computing device 20 of the user. For example in Action004 shown in FIG. 8, the application server 40 is configured to determine a first travel time from the current location to the current vendor location. The application server may determine a second travel time from the current vendor location to the second appointment event and the application server 40 may determine a total event time period equal to the first travel time, the second travel time, and the service time, (Action005 shown in FIG. 8). The application server 40 may send a request, or triggering event 76, to the external server 42 to determine the travel times from the current location to the current vendor location and the vendor location to the second appointment through the corresponding action event that is triggered. The application server 40 is configured to then generate a set of qualified consumers including each identified user record 52 having a determined total event time period within a corresponding free time slot. Whether the determined total event time period is within the corresponding free time slot is determined by the application server 40 once the application server receives the action event data 78 from the external server (in Action008 shown in FIG. 8). The application server 40 is further configured to then transmit a notification 84 including a first promotion including product offering information 68 associated with the selected sales campaign to each mobile computing device 20 associated with each qualified consumer, as shown in FIG. 24.

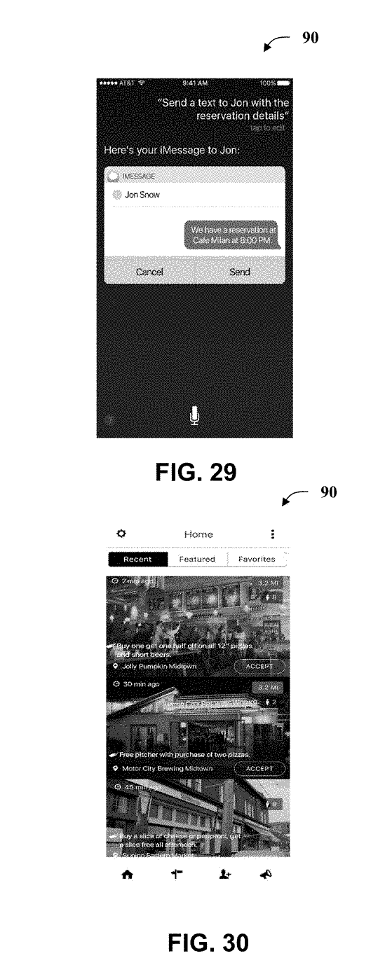

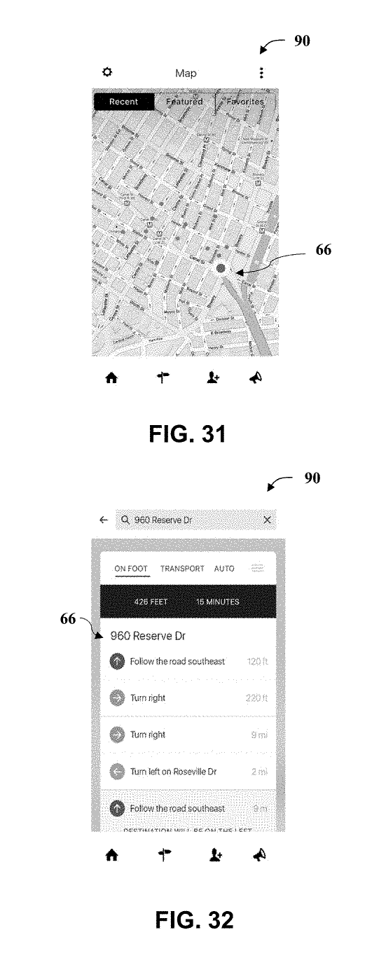

In addition, the application server 40 is further configured to select a second sales campaign having a campaign time period that is similar to the current campaign time period, and identify a second set of qualified consumers associated with the second sales campaign. The application server may then transmit a second notification including a second promotion including product offering information 68 associated with the second sales campaign to each mobile computing device 20 associated with each qualified consumer in the second set of qualified consumers, where the second promotion is transmitted at the same time as the first promotion, as shown in FIGS. 24 and 30). In addition, the application server 40 may then receive a response, or a message 84, from each qualified consumer via a corresponding mobile computing device 20 indicating a selection by the consumer of one of the first and second promotions (shown in FIG. 29). Once the consumer selects one of the promotions 84 through the mobile computing device 20, the application server may send a request to the external server 42 to display the route or map, as shown in FIGS. 31 and 32, to the chosen vendor location 66. In addition, the first sales campaign is associated with a first vendor and the second sales campaign is associated with a different vendor.

In another embodiment, the application server is configured to receive a campaign start request, also known as the triggering event 76, from a vendor via a user computing device 14 including a vendor submitted sales campaign. The application server may then identify qualified consumers associated with the vendor submitted sales campaign upon receiving the campaign start request and then transmit a promotion notification, or message 84, to each identified qualified consumer associated with the vendor submitted sales campaign. The promotion notification includes information associated with the vendor submitted sales campaign. In addition, each sales campaign data record 62 includes a trigger condition, or trigger event 76 to activate the sales campaign at a predetermine time, and the application server is programmed to initiate the selected sales campaign upon detecting the corresponding trigger condition associated with the selected sales campaign as shown in FIGS. 9 and 10. The trigger condition may also include a predefined campaign start-time, where the application server is programmed to detect the trigger condition 76 when a current time is equal to the predefined campaign start-time. The trigger condition may then trigger the corresponding action event, as shown on the action event list 72. The vendor may determine the trigger event when creating the sales campaign. In addition, during the current campaign time period, the application server 40 may be programmed to periodically update the set of qualified consumers.

In another embodiment, the application server 40 is further configured to generate and transmit a message 84 to a first consumer included in the set of qualified consumers. Referring to FIGS. 8-10, the application server 40 is triggered by the triggering event 76 (Action012) that both consumers received the promotion from the vendor, which triggers the application server 40 to transmit the message 84 to the first consumer. The message 84 includes information indicating that a second consumer included in the set of qualified consumers received the promotion from the vendor. The application server 40 receives a request from the first consumer to transmit an invitation message and responsively transmits the invitation message to the second consumer, where the invitation message includes an invitation to meet at the vendor location associated with the promotion, as shown in FIG. 29.

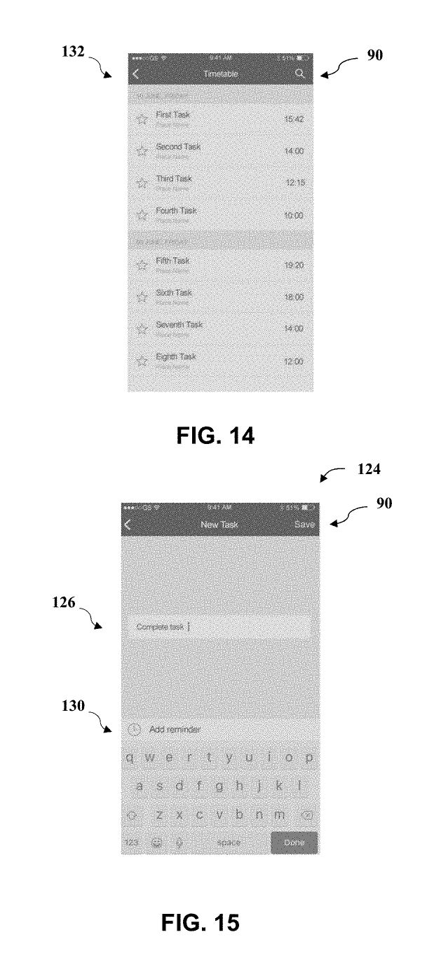

In one embodiment, the application server 40 may allow vendors to login and access corresponding sales campaigns including information such as, for example, vendor ID 64, address data 66, and promotion data 68. For example, the application server 40 may display a login page, receive a unique vendor ID such as, for example, a username and/or password, and identify the vendor account associated with the unique vendor ID to enable the vendor to access information and/or features associated with the corresponding vendor sales campaign account (shown in FIGS. 19-23). In addition, the application server 40 is responsible for brokering all messages in between the user computing device 14 through the website hosting server 34, the sales campaign broker server 36, the search engine server 38, the external server 42, and the internal server. The application server 40 for example, receives messages from the user computing device 14 about actions the consumer has taken to change the calendar data 58 or the vendor has taken to change the sales campaign data 62 such as, for example, adding events/tasks, or requesting rearrangement of the user schedule. The application server 40 is configured to then send the messages to the appropriate server to handle the request such as, for example, the user requests to fill a free time slot with a task on the user task list, the application server 40 is configured to access the internal server 44 to fill the user free time slot with the task through the task optimization action request that may trigger the application server 40 to fill the user schedule with a new task from the prioritized list, as shown in FIGS. 8 and 14, in Action011.

The application server 40 is configured to receive information from the website hosting server 34, the sales campaign broker server 36, the internal server 44, the external server 42, and the search engine server 38, and send the information to the database server 46 to be stored in the database 48. In addition, the application server 40 is configured to receive action events 70 from the website hosting server 34, the sales campaign broker server 36, the internal server 44, the external server 42, and the search engine server 38 and in response is configured to send triggering events back to the plurality of servers. The application server 40 is configured to monitor the action events 70 and triggering events 76 between all of the servers in the system 10. In another embodiment, the database server 46 receives all of the information collected by the application server 40 and stores the information in the database 48. This information includes user preferences, behaviors, sales campaigns (active and inactive), user profiles 54, vendor location, etc.

In another embodiment, the application server 40 is configured to accesses the internal server 44 and the external server 42 to help determine the location of the vendor, the location of the consumer, the location of the consumer appointments, and provide data to the application server 40 to reorganize the user schedule according to the user tasks, reactive rescheduling action event, free time management action event, and predictive rescheduling action event.

The external server 42 is configured to interact with the 3^{rd} party computer server 16 that is outside of the application server 40 such as, for example, Google Places' that provides information on a requested business/location to the user computing device 14 and the consumer may be routed to the vendor. In addition, the external server 42 is configured to connect with the 3^{rd} party computer server 16 using secret authentication mechanisms, application keys, call different methods on the external server 42, APIs, and reformat the results of the data back for use by the application server 40 so that the application server 40 can send the data to the website hosting server 34 to be displayed on the user computing device 14. The external server 42 is configured to be a bridge between the products and/or services completely separate from the application server 40. The products and/or services that are outside of the application server 40 include all external services, for example, Google Places™, Yahoo™, Facebook™, etc. These products and/or services may provide information to the application server 40 to better determine the consumer's calendar data 58, current location, and/or any information that may affect the sales campaign that is outside of the system 10.

In another embodiment, the external server 42 includes action events such as, a location action which returns information about the user's location, and information related to the user current location, an address lookup action that provides a specific requested address, a basic directions action which provides the basic directions to the specific vendor location or to the second appointment, a business/place information action which returns detailed information about the requested business/place of interest (for example, address, business hours, peak/rush times, reviews, website, and/or basic information about vendors surrounding the vendor location), and a traffic action which returns predictive and/or real-time information related to traffic, construction, accidents, and general information that may affect ideal estimated time of arrival when calculating directions from the location action.

The internal server 44 includes a task optimization action event, a reactive re-scheduling action event, a free time management action event, and a predictive scheduling action event. The internal server is configured to perform the actions of the above mentioned action events and to communicate by sending and receiving requests from the internal action events to the application server 40 and from the application server 40 to the internal action events. The internal server 44 is responsible for knowing how to communicate to the internal action events and translating the results to the application server 40. The internal server action events include the task optimization action event which is responsible for analyzing the user schedule and tasks. The task optimization action event is configured to provide options to the consumer with any outstanding time slots in the schedule. The internal server 44 is configured to prioritize the tasks based on proximity to surrounding events/tasks with locations such as, for example, the user has an appointment scheduled and the user has a task created to pick up the dry cleaning and the location of the dry cleaning is close in proximity to the scheduled appointment. The internal action may favor scheduling the dry cleaning pickup before or after the scheduled appointment. In addition, the internal server 44 is configured to estimate the time to complete the task, which may be factored into finding the appropriate slot in the user schedule, prioritize the task which may weigh whether or not a task is slotted over other tasks, even if a given less-priority task may satisfy one of the above concerns better than the high-priority task.

In addition, another internal server action event is a reactive rescheduling action event which is responsible for re-arranging the user schedule based on real-time traffic or close to real-time changes in the user behavior. The internal server 44 may receive a triggering event 76 that the consumer may not make the second appointment due to an accident on the route to the second appointment. The reactive rescheduling action event may then be triggered to rearrange the consumer's calendar so that the consumer is not late to the second appointment (Action007 shown in FIG. 8). Another example of the reactive rescheduling action includes if the consumer is stuck in traffic and the estimated time of arrival changes, the reactive rescheduling task is configured to respond to the external action changes in real time and trigger the application server 40 to drop the non-essential task in favor of the user reaching a higher-priority scheduled appointment on time.

Another internal action includes a free time management action, which is responsible for providing users with suggested activities or events to fill a particular free time slot in the user's schedule. For example, the free time management action receives a request from the application server 40 to find an appointment, a task, or an event to fill the user free time slot, but this is not an automatic process. The user computing device 14 sends a message to the application server 40 which sends a message to the internal server 44, which then sends the message to the free time management action. The free time management action takes into consideration the user input about the consumer current mood and activities the user may be interested in viewing, and takes into account the amount of free time the user has as well as the location of surrounding scheduled events and tasks to provide activities that meet the criteria provided by the user, but that also fit into the amount of time the user has for the activity, accounting for travel time in-between surrounding scheduled events and tasks. The user is given an opportunity to review and select from the suggestions given by the free time management action, and the free time management action is configured to inform the internal server 44 of any final decisions made by the user. The internal server 44 may send the final decision back to the application server 40 to update the calendar information 58.

In addition, another internal action on the internal server 44 includes a predictive scheduling action. The predictive scheduling action is configured to run simulations on potential issues with the user current schedule and identify criteria as to when these issues may occur. The predictive scheduling action is configured to flag the invisible issue from the internal server 44 through the application server 40, so if the criteria is met, the application server 40 can trigger a notification to the user, or automatically re-arrange through the internal server the user schedule such as, for example, the user scheduled a task into the user schedule and based on traffic patterns, the user may potentially be late to the second appointment if the traffic is not ideal. The predictive scheduling action is configured to set an invisible flag at a particular interval informing the application server 40 to check the user current location and real time traffic through the external server 42 before the user leaves for the scheduled event. If the user is not in an ideal location and/or real time traffic is not ideal, the user may be informed of this information and prompted to take corrective action, possibly by leaving earlier than usual for the event, or sending a notification to other event attendees that the user may be late by a given amount of time.

In one embodiment, the triggering event may include a traffic accident on the user's route to the second appointment. Due to the traffic accident, the application server 40 may request and receive traffic data including the amount of time for sitting in traffic and/or any alternative routes for the user from the 3^{rd} party computer server 16 through the external server 42. The application server 40 may initiate the data search operation including, determine a current location of the mobile computing device 20, receiving location data from the corresponding mobile computing device 20, review the received traffic data to identify the total amount of time to sit in traffic or the alternative route, and determine the message to be sent to the internal server 44 to activate the reactive rescheduling action event. Another message may be sent to the user mobile computing device 20 to notify the user of the delay or if the user may have to leave earlier for the second appointment.

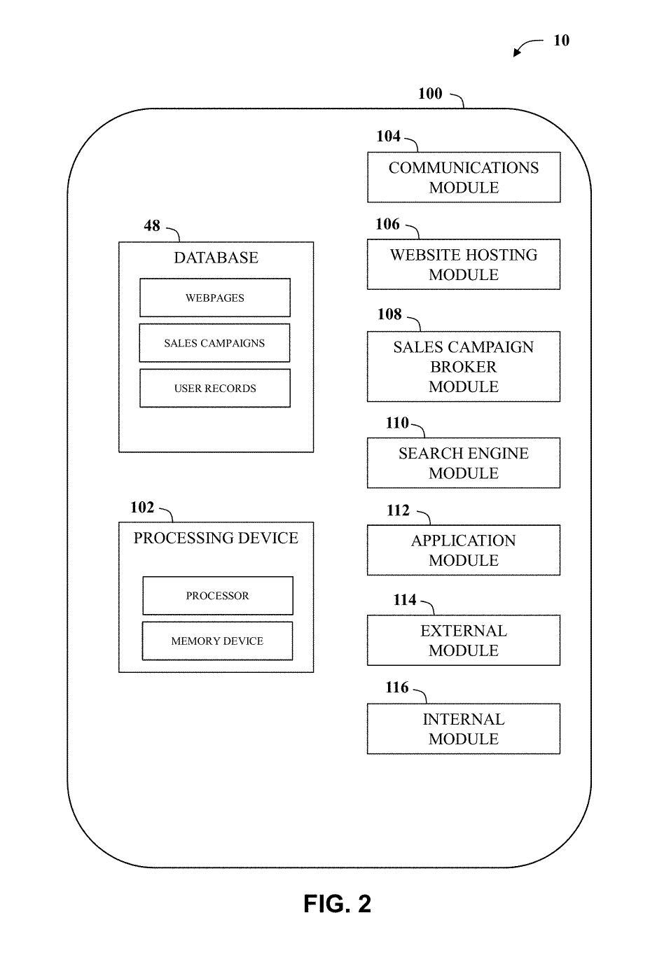

Referring to FIG. 2, in one embodiment, the system 10 may include a system server 100 that is configured to perform the functions of the website hosting server 34, the sales campaign broker server 36, the search engine server 38, the application server 40, the external server 42, the internal server 44, and the database server 46. In the illustrated embodiment, the system server 100 includes a processing device 102 and the database 48.

The processing device 102 executes various programs, and thereby controls components of the system server 100 according to user instructions received from the user computing device 14. The processing device 102 may include memory, e.g., read only memory (ROM) and random access memory (RAM), storing processor-executable instructions and one or more processors that execute the processor-executable instructions. In embodiments where the processing device 102 includes two or more processors, the processors can operate in a parallel or distributed manner. In an example, the processing device 102 may execute a communications module 104, a website hosting module 106, a sales campaign broker module 108, a search engine module 110, an application module 112, an external module 114, and an internal module 116.

The processing device 102 may also include a memory device for storing programs and information in the database 48, and retrieving information from the database 48 that is used by the processor to perform various functions described herein. The memory device may include, but is not limited to, a hard disc drive, an optical disc drive, and/or a flash memory drive. Further, the memory device may be distributed and located at multiple locations.

The communications module 104 retrieves various data and information from the database 48 and sends information to the user computing device 14 via the communications network 18 to enable the user to access and interact with the system 10. In one embodiment, the communications module 104 displays various images on a graphical interface of the user computing device 14 preferably by using computer graphics and image data stored in the database 48 including, but not limited to, calendar information 58, user records 52, sales campaign data, notification, promotions, messages, and/or any suitable information and/or images that enable the system 10 to function as described herein.

The website hosting module 106 may be programmed to perform some or all of the functions of the website hosting server 34 including hosting various web pages associated with one or more websites that are stored in the database 48 and that are accessible to the user via the user computing device 14. The website hosting module 106 may be programmed to generate and display webpages associated with a website in response to requests being received from users via corresponding web browsers.

The sales campaign broker module 108 may be programmed to perform some or all of the functions of the sales campaign broker server 36 including hosting, receiving and storing the campaign data, both active and inactive, and transmitting a signal of the active sales campaign to the application module 112.

The search engine module 110 may be programmed to perform some or all of the functions of the search engine server 38 including generating and storing search data in response to the user search request and/or application module 112 search requests.

The application module 112 may be programmed to perform some or all of the functions of the application server 40 including monitoring activities associated with the users including monitoring active and inactive sales campaigns, determining whether the total time is within the similar free time slot of the user, detecting trigger events from actions, and/or generating the messages associated with the monitored activities between all of the modules.

The external module 114 may be programmed to perform some or all of the functions of the external server 42 including generating, receiving, and storing the external data including data from the 3^{rd} party computer server 16, location action events, the business/place action events, and the traffic action events.

The internal module 116 may be programmed to perform some or all of the functions of the internal server 44 including generating, receiving, and storing the internal information including data from the task optimization action events, the reactive rescheduling action events, the free time management events, and the predictive scheduling events.

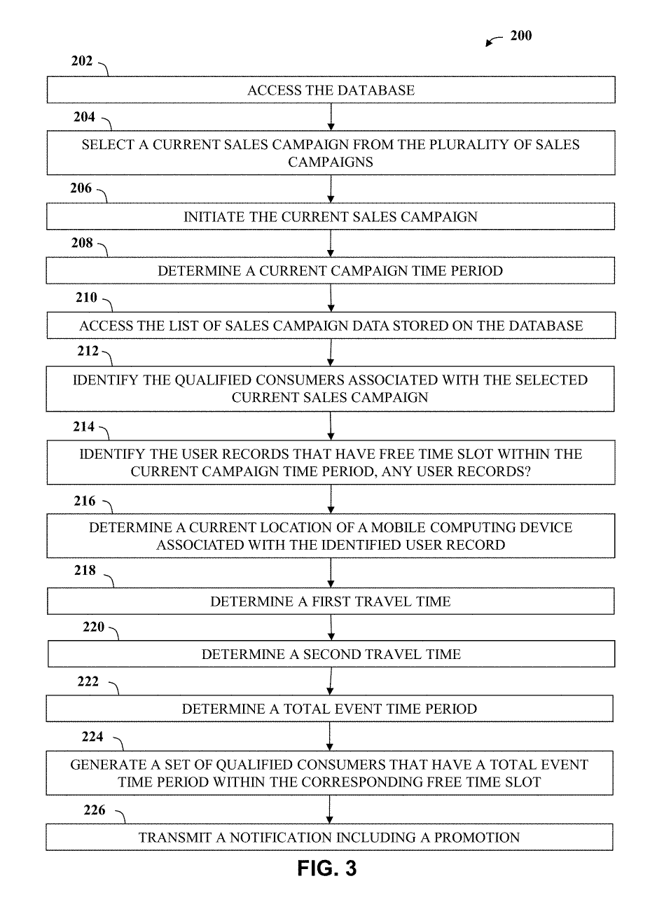

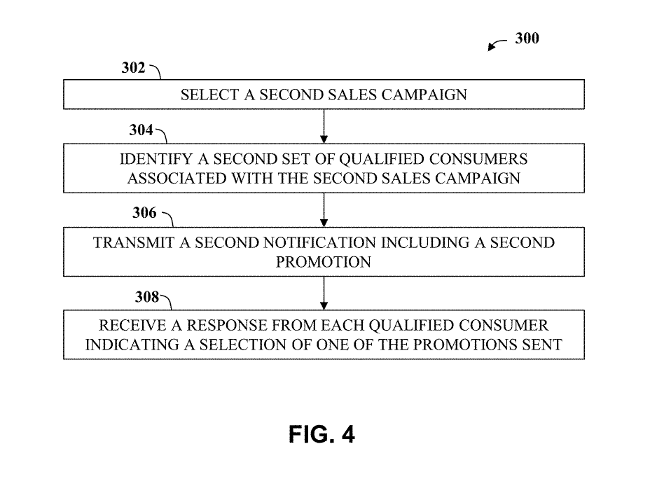

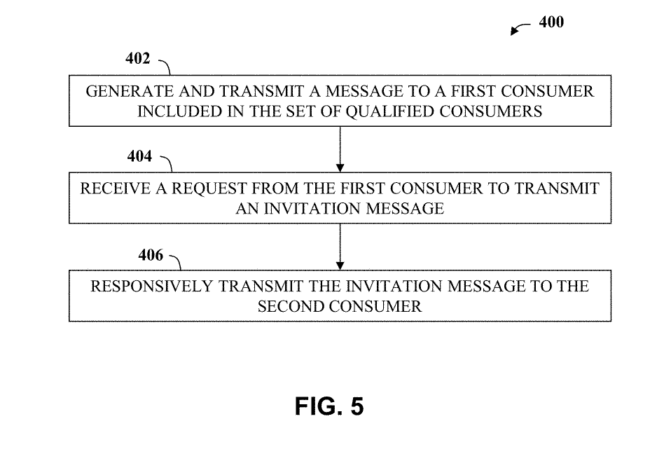

FIGS. 3-5 are flowcharts of methods 200, 300, and 400 that may be used with the system 10 for providing a reverse auction via the user computing device 14 and generating and displaying information to the users on a website via a mobile computing device 20. The methods include a plurality of steps. Each method step may be performed independently of, or in combination with, other method steps. Portions of the methods may be performed by any one of, or any combination of, the components of the system 10. FIGS. 11-32 are exemplary graphical displays that may be displayed by the system 10.

In the illustrated embodiment, in method step 202, the application server 40 accesses the database 46 that includes a plurality of sales campaign data records. Each sales campaign data record 62 is associated with a retail product offering and includes a unique vendor ID 64 associated with a vendor, address data 66 indicating a physical location of the vendor, and promotion data 68 including a campaign time period, a service time, and product offering information. In addition, the campaign time period is the period of time during which the retail product offering is available to consumers, and the service time is the amount of time required to provide the retail product offering to a consumer.

In method step 204, the application server selects a current sales campaign from the plurality of sales campaigns. In method step 206, the application server 40 initiates the current sales campaign. The application server 40 receives the current sales campaign from the sales campaign broker server 36, because the sales campaign becomes active which triggers the application server 40 to request the sales campaign data 62 from the database 48.

In method step 208, the application server 40 determines a current campaign time period, a current service time, and a current vendor location associated with the current sales campaign. In one embodiment, the data may be received from a mobile computing device 20 associated with a vendor. In another embodiment, the request to enter data may be initiated by the vendor via the website. In addition, the application server 40 may be programmed to initiate a modification operation at a predefined period of time and/or upon receiving an indication of activities associated with the user schedule. The sales campaign 62 may be created through the website hosting server 34 by the user computing device 14. The website hosting server 34 communicates with the sales campaign broker server 36 where the sales campaign may be received and stored.

In method step 210, the application server 40 accesses the list of sales campaign data 60 being stored on the database 48 to determine the sales campaign associated with the vendor ID and the start-time of the sales campaign time period, which will trigger the application server 40 to begin searching for consumer records. The application server 40 may also send the request to the search engine server 38 to query the list of sales campaigns 60. Upon determining the vendor ID the application server 40 receives the location of the vendor, the campaign time, the service time, and data associated with the vendor ID. The location of the vendor can either be obtained through the sales campaign broker server 36 by the website hosting server 34 when the sales campaign was first created or through the external server 42 and the business/place action which may trigger the 3^{rd} party computer server 16 to determine the location of the vendor. The application server 40 may receive the specific vendor ID which is associated with the data stored on the sales campaign broker server 36. The campaign time can be any time that the vendor would like to send promotions to consumers who have a free time slot within the campaign time period. The campaign time can be either premade or automatic. An automatic campaign time is when the campaign time initiates the active sales campaign, as soon as the vendor creates the sales campaign, where the application server 40 may continue with the next method step automatically. If the campaign time is premade, the sales campaign may be stored on the database 48 until the campaign time becomes an active sales campaign, and proceed with the next method step.

In method step 212, the application server 40 identifies qualified consumers associated with the selected current sales campaign. Further, the application server 40 accesses the database including a plurality of user records 50, where each user record 52 includes a unique user ID 54 associated with a corresponding consumer, a mobile ID 56 associated with a mobile computing device 20, and data associated with a plurality of calendar events 58. Each calendar event includes a calendar time period and location, and the plurality of calendar events include a first appointment event, a second appointment event, and a free time slot between the first appointment event and the second appointment event.

In method step 214, the application server 40 identifies user records that have free time slots that are within the current campaign time period. The application server 40 may send a request to the search engine server 38 to search the database 48 for the user record 52 with free time slots within the campaign time period. The consumer may use the user computing device 14 to enter the user record 52, including calendar data 58 through the website hosting server 34, which may send the data to the database server 46 to be stored.

For example, the campaign time period can run from 12:00 pm until 2:30 pm and the similar free time slot could be from 11:00 am until 12:30 pm, or from 12:00 pm until 1:00 pm, and/or from 1:45 pm until 5:00 pm. So long as the free time slot overlaps the campaign time period at some point in time, the user profile 54 may be included in the list of user profiles 54 with free time slots within the campaign time period. If the application server 40 does not receive any user profiles with a similar free time slot, the application server 40 may continue querying for user profiles 54 until the active sales campaign becomes an inactive sales campaign (Action001 shown in FIG. 8).

In method step 216, the application server 40 determines a current location of a mobile computing device associated with the identified user record 52. The application server 40 may receive from the external server 42 the current location of the user by requesting from the 3^{rd} party computer server 16 to locate the user mobile computing device 20 through the mobile ID 56 (Action004 shown in FIG. 8).

In method step 218, the application server 40 determines a first travel time from the current location to the current vendor location. In method step 220, the application server 40 determines a second travel time from the current vendor location to the second appointment event.

In method step 222, the application server 40 determines a total event time period equal to the first travel time, the second travel time, and the service time. The total time is determined by receiving from the external server 42 the first time and the second time. The service time was already received from the database 48. The application server 40 determines the first time by requesting from the external server 42 the amount of time to travel from the user current location to the vendor location, and the second time is determined by requesting from the external server the amount of time to travel from the vendor location to the second appointment. When the external server 42 determines the travel time, the external server 42 uses the traffic action event to see if there are any current accidents or alternate routes for the consumer to take. The traffic action event may trigger the 3^{rd} party computer server 16 to determine the current traffic activity for both the first time and the second time (Action005 shown in FIG. 8).

In method step 224, the application server 40 generates a set of qualified consumers including each identified user record 52 having a determined total event time period within a corresponding free time slot. The application server 40 has already received the free time slot of the user from the database 48 and determined the total time in step 222. For example, the user may have a free time slot from 12:00 pm until 1:00 pm and the total time may be 1 hour and 30 minutes. The user's free time slot is only 1 hour and therefore, the total time is not within the free time slot of the user, but if the free time slot of the user was from 12:00 pm until 2:00 pm, the total time would be within the free time slot.

In method step 226, the application server 40 transmits a notification including a first promotion that includes product offering information associated with the selected sales campaign to each mobile computing device associated with each qualified consumer. The application server 40 generates and transmits a signal including the promotion to the mobile computing device 20 to cause the website hosting server 34 to display the notification message on the mobile computing device 20, in method step 226. For example, the application server 40 may generate a promotion 84 (shown in FIGS. 24, 25, 27, and 30) upon detecting whether the total time is within the free time slot of the consumer. The application server 40 may send the promotion through the website hosting server 34 to the user computing device 14.

In method step 228, the application server 40 receives a campaign start request from a vendor via a user computing device 14 including a vendor submitted sales campaign. In method step 230, the application server 40 identifies qualified consumers associated with the vendor submitted sales campaign upon receiving the campaign start request. In method step 232, the application server 40 transmits a promotion notification to each identified qualified consumer associated with the vendor submitted sales campaign, where the promotion notification includes information associated with the vendor submitted sales campaign.

When filling the consumer's free time slots, the application server 40 may communicate with the internal server 44 to use the task optimization action, the reactive rescheduling action, the free time management action, and/or the predictive scheduling action. In addition, the external server 42 may use the location action, the business/place of business action, and/or the traffic action. For example, the consumer may have a free time slot from 1:00 pm until 2:00 pm and the vendor sent the promotion to the consumer, but an accident happens while the consumer is at the vendor location, and the consumer may be late to the second appointment. The internal server 44 may cancel a task already in the user calendar 58, or reschedule the user's schedule, or have the user leave earlier from the vendor location in order to make it to the second appointment on time. Appointments may take priority over tasks on the user schedule.

In method step 234, the application server 40 determines that each sales campaign data record 62 includes a trigger condition, and the application server is programmed to, in method step 236, initiate the selected sales campaign upon detecting corresponding trigger condition associated with the selected sales campaign. For example, in FIG. 10, with vendor ID “Starbucks05”, the Action002 record is triggered by the sales campaign becoming active, which will begin searching the database 48 for user profiles 54 and will send the list of user profiles from the database 48 to the application server 40.

In method step 238, the application server 40 determines that the trigger condition that includes a predefined campaign start-time, and the application server is programmed, in method step 240, to detect the trigger condition when the current time is equal to the predefined campaign start-time. In method step 242, the application server 40 is programmed to periodically update the set of qualified consumers during the current campaign time period. The application server 40 may continue querying the database 48 for consumers within the predefined proximity.

In method step 302, the application server 40 selects a second sales campaign having a campaign time period that is similar to the current campaign time period. In method step 304, the application server 40 identifies a second set of qualified consumers associated with the second sales campaign.

In method step 306, the application server 40 transmits a second notification including a second promotion including product offering information associated with the second sales campaign to each mobile computing device associated with each qualified consumer in the second set of qualified consumers, where the second promotion is transmitted at the same time as the first promotion. The user computing device 14 receives the promotions through the website hosting server 34 which receives the promotions from the application server 40. If the second total time is not within the free time slot of the user, the application server 40 may continue querying for user profiles 54 until the second active sales campaign becomes an inactive sales campaign.

In method step 308, the application server 40 receives a response from each qualified consumer via a corresponding mobile computing device 20 indicating a selection by the consumer of one of the first and second promotions. The application server 40 receives the response from the user and sends an acceptance response to one sales campaign and a decline response to the other sales campaign. The user may also decline both promotions. For example, the consumer may accept the first sales campaign that ran from 12:00 pm until 1:00 pm because the total time was only 30 minutes before the consumer's second appointment, and the second sales campaign would include the total time of 1 hour and 30 minutes. Now, even though the consumer may have a free time slot that fits the 1 hour and 30 minutes total time the consumer may not want to spend that much time at lunch.

In method step 310, the application server 40 determines that the first sales campaign is associated with a first vendor and the second sales campaign is associated with a different vendor. The application server 40 receives unique vendor ID 64 associated with each vendor which separates the two different sales campaigns.

In method step 402, the application server 40 generates and transmits a message to a first consumer included in the set of qualified consumers including information indicating that a second consumer included in the set of qualified consumers received the promotion from the vendor. The list of user profiles includes all of the consumers that had the free time slot within the current campaign time period. The application server 40 may also send a request to the search engine server 38 for all user profiles that received the promotion. The search engine server 38 may search the database 48 for all users that received the promotion. The application server 40 receives from the database 48 a message that includes a second user profile that also received the promotion from the vendor. The message may include the user profile with the second user location and the free time slot of the second user.

In method step 404, the application server 40 receives a request from the first consumer to transmit an invitation message and, in method step 406, responsively transmit the invitation message to the second consumer, the invitation message including an invitation to meet at the vendor location associated with the promotion. The application server 40 receives the second message from the first user computing device, and the second message includes an invitation to meet the second user at the vendor location. The first user computing device may send the invitation to connect with the second user through the website hosting server 34, which may trigger the website hosting server 34 to send the invitation to the second user computing device. The first and second consumers do not have to accept the promotion from the vendor in order to be invited to meet each other at the vendor location.

In one embodiment, the system 10 may access the corresponding user records 52 to determine a messaging API associated with an operating system of the mobile computing device 20 and generates the message as a function of the retrieved messaging API to enable the mobile computing device 20 to display the received message. In one embodiment, each user record 52 includes information associated with the mobile computing device 20 including a unique mobile ID and message API. In another embodiment, the user records 52 may include a message preferences, such as, for example, an email, text message, push messaging, automated phone call, and the like. The application server 40 identifies the messaging preference associated with the user records 52 and generates the notification message based on the message preference. In addition, the application server 40 may also access the messaging information 84 to identify contact information associated with additional users associated with the user and generate and transmit similar notifications including the information associated with the user to the additional users designated by the user and identified in the messaging information 84.

In addition, the user may have the option to create the user profile 54 using a user interface 32 of the user computing device 14 in the application program setting to help the vendor better target the user's personal needs. The user may also have the ability to connect social media accounts, for example a scheduling app, to increase the accuracy of the sales campaign used by the vendors. In addition, the users may have the ability to hide or disable themselves in the mobile computing device 20 to prevent sales campaigns from targeting them at any time. When targeted and contacted by a sales campaign, the user may receive a notification on the user computing device 14 actively running the sales campaign. These notifications provide a non-obtrusive way for the user and the vendor (or user to user) to communicate effectively. Interchangeably, the user is known as the public or consumer and the vendor is known as the business or business owner.

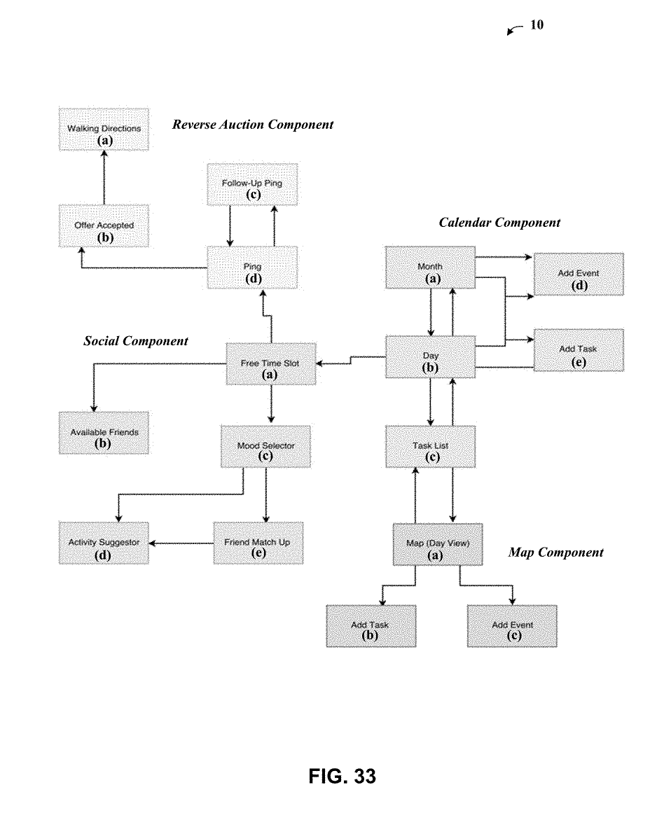

In another embodiment, the system 10 may also be illustrated in FIG. 33 which displays the relationships in the system 10. In addition, the system 10 may allow the user computing device 14 to interact with the website hosting server 34 via the “day” screen (also known as calendar component, d). The day screen (shown in FIG. 11) lists the user's events and appointments for the current day. These events and appointments may be added through the website hosting server, and may be pulled from e-mail, text messages, and other calendar applications 58. In another embodiment, the user may add a new event or appointment from the day screen by clicking an “add event” button. The website hosting server 34 may show the user to an “add event” screen of the calendar component 58, which presents the user with a form that allows the user to enter in an event title 118, start and end times 120, a location for the event 120, as well as other attributes and preferences that may be useful for the even. Upon completion of the new event form, the user may choose to save the event or cancel and not save the new event. If the user chooses to save the event, the website hosting server 34 adds the new event into the day screen and the internal server 44 re-calculates the free time available to the user between events.

In addition, the user may interact through the website hosting server 34 and the internal server with the calculated free time slots in-between the scheduled events by choosing a free time indicator in-between events (not shown). Upon choosing the free time slot (also known as the social component, a), the user may be presented with options on how to fill the free time slot. The user may be prompted to follow a series of steps to help the system 10 provide options on how to fill the selected free time slot based on the user current preferences and desires. If the user has friends that also use the system 10, the user may search for friends that also have free time at the same time as the user (also known as social component, b).

In another embodiment, if the user has a friend that is free at the same time as the selected free time slot, the user may invite the friend through the website hosting server 34 to the activity that the user chose to fill the free time slot with. Now, if the user does not have any friends that are available during the selected free time slot, the step is bypassed. The website hosting server 34 may receive the user current mood (social component, c). This step aims to prevent the suggestion of activities that the user may otherwise enjoy, but may not be in the mood for. After receiving the user current mood, the system 10 may suggest activities through the application server 40 that may be accomplished within the free time slot, described above, using the external server 42 and the internal server 44 so that the user may not be late to the next scheduled event. The external server 42 may determine the distance between event locations and cross referencing against real-time and/or estimated traffic patterns using the 3^{rd} party computer server 16 (social component, d). In addition, the user may be paired with another user on the system 10 that is participating in the same event at the same time (social component, e). The users do not have to be real-world friends or have any previous interaction in order to be paired through the system 10. if the user wishes to be paired with another user, both users may be able to see basic profile information about the other user, including any social rating system that may be built into the system 10 to rate the integrity of the users through the website hosting server 34. Once the user has moved through the series of steps for filling the free time slot and confirmed the selected event, the user may be returned to the day screen where the website hosting server 34 may display the new activity on the calendar 58.

In another embodiment, the website hosting server 34 may allow the user to move between different presentation options of the calendar 58. The user may view the schedule via a monthly view (calendar component, a), or by a day-may view (map component, a). The monthly view may show an at-a-glance view of the user events and/or appointments. Each appointment or event may be represented by showing a basic indicator, such as a small dot (shown in FIG. 31), on every day that the user calendar 58 includes appointments and/or events. In addition, the month view and day view may be toggled back and forth easily via a button on the day view screen (not shown).

In addition, the map view may show all scheduled events spatially on the map once the external server 42 communicates with the website hosting server 34 to display the map on the user computing device 14. The external server 42 may communicate with the 3^{rd} party server for example, Google Maps™, Apple Maps™, MapBox™, etc. Each event may be represented on the map by individual map pins. The map view also has the ability to display the transit direction to navigate between events through the current day.

In another embodiment, shown in FIGS. 14-15, the website hosting server 34 may display a task screen 124 (calendar component, c) where the individual tasks may be listed that the user may need to complete during the day. The tasks do not have specific start times and end times like the event or appointment does. Tasks are listed on the task screen in order of priority, with the most important or urgent tasks at the top of the list, and the least important or urgent tasks at the bottom of the list. Task priority may be rearranged through the website hosting server 34 by being drug around on the display screen by the user. Any of the tasks may be added to the day screen by dragging the task into the free time slot of the calendar 58. The process is similar to the reverse auction process for filling a free time slot with promotions described above, but with tasks. Any new tasks may be added via an “add task” button (calendar component, e) on the task list (not shown).

In one embodiment, the website hosting server 34 may display on the user computing device 14, an opening for the user to determine a title of the task 126, an estimate of the duration of the task 128, set the priority of the task 130, and any other potentially useful attributes and information about the task. The user may save the task or cancel the task through the website hosting server 34 on the user computing device 14. Once the task has been saved or canceled, the user computing device 14 may be returned to the task list screen 132.

In addition, the system 10 may notify the user via a ping, shown in FIG. 16, (reverse auction component, d) during the specific time slot. The ping may be a local offer that fits the user's mood and preferences at the specific point in the day, for example, a sushi special at lunch time. Any local business establishment nearby may be able to outbid one another for the user, as described above (reverse auction component, c, d). Eventually, the user may accept the offer/promotion 84, shown in FIG. 17, (reverse auction component, b), and will be directed to the vendor establishment (reverse auction component, a), as described above.

The user computing device 14, a, or mobile computing device 20 represents the user device and the system 10 display through the website hosting server 34. The system 10 may be responsible for presenting the user interface 32 to the user, and may be the user's window into the actual system 10. In addition, the system 10 may be responsible for retaining cached versions of all information provided to the system 10 via the application server 40, reporting user actions and changes back to the application server 40, and syncing offline data with the application server 40 when the user computing device 14 comes into range of new connections.

In another embodiment, an authentication server, b, may be responsible for authenticating the user and managing the user identity through the website hosting server 34. After establishing the user identity, login identifiers/tokens and information are reported to the user computing device via the website hosting server 34 and to the application server 40 so that the user maintains a long-term logged in session during the use of the system 10. The authentication server is responsible for managing the user identity throughout the system 10.

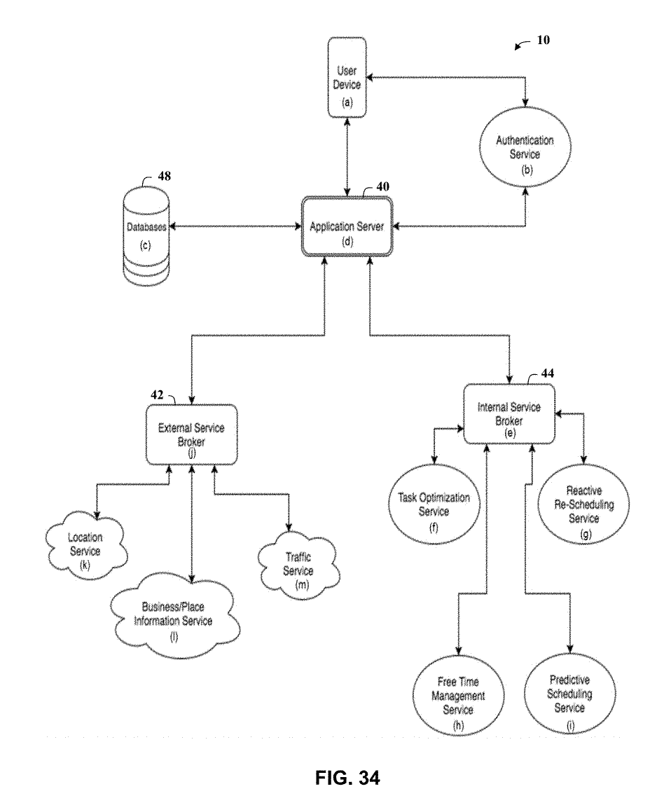

In yet another embodiment, illustrated in FIG. 34, the system 10 includes the application server 40, d, which may be responsible for brokering all messages in between the user computing devices 14 and the application server backend services. In addition, the application server 40 may receive messages from the user device about actions the user has taken to change the application state, such as, for example adding events/tasks, or requesting auto-rearrangement of the schedule, and/or sending messages to the appropriate server to handle the request. The application server 40 may receive information from the various servers in the system 10 and relay information back to the user computing device via the website hosting server 34 to update the user's local cached application state. In addition, the application server 40 may include several application servers to exist in order to hand the real-world system 10. With multiple application servers, the user computing device may interact with the server that best handles the request, determined by a load balancer sitting in front of the application servers (not shown).

In one embodiment, the database 48 represents the datastores of the system 10, where all of the necessary information about user preferences and behaviors are tracked. The database 48 interacts only with the application server 40 instead of directly with the other servers so that there is one single point of contact for all interaction in the system 10. Information is written before the user device is notified the action may be complete, so that if any issue occurs during the processing of the information the requested action and saving the results to the database 48, processing may be reverted and the user computing device 14 can be notified of the failure. The user computing device 14 may display the failure, and prompt for retrying the action if applicable through the website hosting server 34.

The external server 42, also known as the external service broker (j), is responsible for the interaction between the servers outside of the system 10 (3^{rd} party computer server 16). Actions that require communicating with the 3^{rd} party computer server 16 such as Google Places or another server that provides information on a requested business/location may be routed through the external server 42. The external server 42 may be responsible for knowing how to connect to the outside servers, including knowing secret authentication mechanisms/application keys, and have knowledge of how to call different methods on the external server 42 APIs and how to reformat the results so that the system 10 can understand and utilize the results. The external server 42 should do little to no processing on its own, but rather should act as a bridge between the application server 40 and the 3^{rd} party computer server 16.

In addition, the external server 42 includes events that are triggered by triggering events to communicate with the 3^{rd} party computer server 16. The events include the location event (also known as the location service k), the business/place event (also known as the business/place information service l), and the traffic event (also known as the traffic sevice m).

The location event may return information about the user location and information related to the user location using basic business or place of interest information in a radius around the user location, an address lookup service, and/or basic directions (without accounting for more detailed information like traffic patterns).

The business/place event may return detailed information about a requested business/place of interest using addresses, business hours, peak/rush times, review of the vendor, external resources (website), and/or basic information about other places of interest surrounding the location of the requested vendor or place of interest.

The traffic event may return predictive and/or real-time information related to traffic, construction, accidents, and generally information about trigger events that may affect ideal estimated time of arrival when calculating directions form the location event, shown in FIG. 18.

In another embodiment, the internal server 44, also known as the internal service broker may be responsible for communicating to-and-from the internal events that do most of the processing in the system 10. As described above about the external server 42, the internal server 44 is responsible for knowing how to communicate to the internal events, and translating results to the application server 40, which may communicate changes to the user computing device 14 and database 48. The events include the task optimization event (also known as the task optimization service f), the reactive re-scheduling event (also known as the reactive re-scheduling service g), the free time management event (also known as the free time management service h), and the predictive scheduling event (also known as the predictive scheduling service i).

The task optimization event may be responsible for analyzing the user schedule and tasks, and providing options as to how the user may slot outstanding tasks in schedule. Options may include prioritizing slotting tasks in the most optimal way. The factors that influence the optimization options given to the user may include if the location is tied to a task the proximity to surrounding events/tasks with specific locations may be considered, such as for example, if the user has an appointment scheduled and the user has a task created to pick up their dry cleaning. The location where the user has to pick up the dry cleaning is in close proximity for the scheduled appointment, the event may favor scheduling dry cleaning pickup before or after the scheduled appointment, because the user is in proximity to each location. Another factor includes the estimated time to complete the task and the priority of the task will weight whether or not the task is slotted over other tasks, even if the given less-priority task may satisfy one of the above concerns better than the high-priority task.

The reactive re-scheduling event may be responsible for re-arranging the user schedule based on real-time or close to real-time changes in the user's behavior such as, for example, if the user is stuck in traffic and the estimated time of arrival changes. This makes it no longer possible for the user to complete a scheduled, but non-essential task and still make it to an important, scheduled appointment. The reactive re-scheduling service is responsible for responding to these changes in reality and dropping the non-essential task in favor of the user reaching their higher-priority scheduled appointment on time.

The free time management event may be responsible for providing users with suggested activities or events to fill a particular free time slot in the user schedule. This occurs when the user through the user computing device 14 requests that the system 10 help find something to fill the free time slot with, and is not an automatic process. The free time management event takes user input about the current mood, what types of activities the user is interested in viewing, and takes into account the amount of free time the user has as well as the location of surrounding scheduled events and tasks to provide activities that meet the criteria provided by the user, but that also fit into the amount of time the user has for the activity, accounting for travel time in-between surrounding scheduled events and tasks. The user is given an opportunity to review and select from the suggestions given by the event, and the event informs the internal server 44 of any final decision made by the user triggering the application server 40 to update the user computing device 14 and the database 48 with the selected activity.

The predictive scheduling event may be responsible for running simulations on potential issues with the user current schedule, and identifying criteria as to when these issues may occur. These issues can then be invisibly flagged by the internal server 44, so that if these criteria are met, the internal server 44 can trigger notifications to the website hosting server 34 and the user computing device 14, or automatically re-arrange the user schedule through the reactive re-scheduling event based on these predicted issues coming to fruition. For example, the user has scheduled the day, and slotted some tasks of the task list into the schedule. The predictive scheduling event runs a check against the proposed schedule and determines that based on traffic patterns, the user could be late to the second appointment event if traffic is less than ideal. The event will set an invisible trigger flag at a particular interval informing the internal server 44 to communicate with the external server 42 to check the user's location and real time traffic before the user leaves for the scheduled second appointment. If the user is not in an ideal location and/or real time traffic is not ideal, the user may be informed of this information and prompted to take corrective action, possibly by leaving earlier than usual for the second appointment, or sending a notification to other event attendees that the user will be late by a given amount of time.

In another embodiment the system 10 may be a web based component meant to facilitate easier business interaction with potential users.

As illustrated in FIGS. 19-23, the website hosting server 34, may display the competitor analysis section, where business owners or vendors may be able to view a feed of current offers or promotions being run by competitors on the user computing device 14. The vendor can select the time frame and increment to view, and a corresponding graph for the time frame will appear in the main field of view. Tabs 134, including the competitor analysis tab 136, shown in FIG. 19, may allow the vendor to toggle between current competitor offers (one, two, and three shown). In addition, bars and lines on the graph show customer traffic, social media mentions are shown next to the main graph, and main statistics on views, likes, comments, and actual visits for the offer or promotion in question appear under the graphic display.

The demographics tab 138, shown in FIG. 20, may be able to segment the consumer/user base into age groups (or any other categorization that makes sense for the business). The view allows vendors to toggle between daily, weekly, and monthly statistics, and will further allow for selection of specific dates or date ranges on the user computing device 14. In the center and on the right, the number of visitors to the vendor within the specified date range are shown and broken down by demographic category. On the left, social media posts are filtered by platform and color coded to show which demographic the promotion is reaching. Through the website hosting server 34 and the user computing device 14 the graphs and views may be customized.

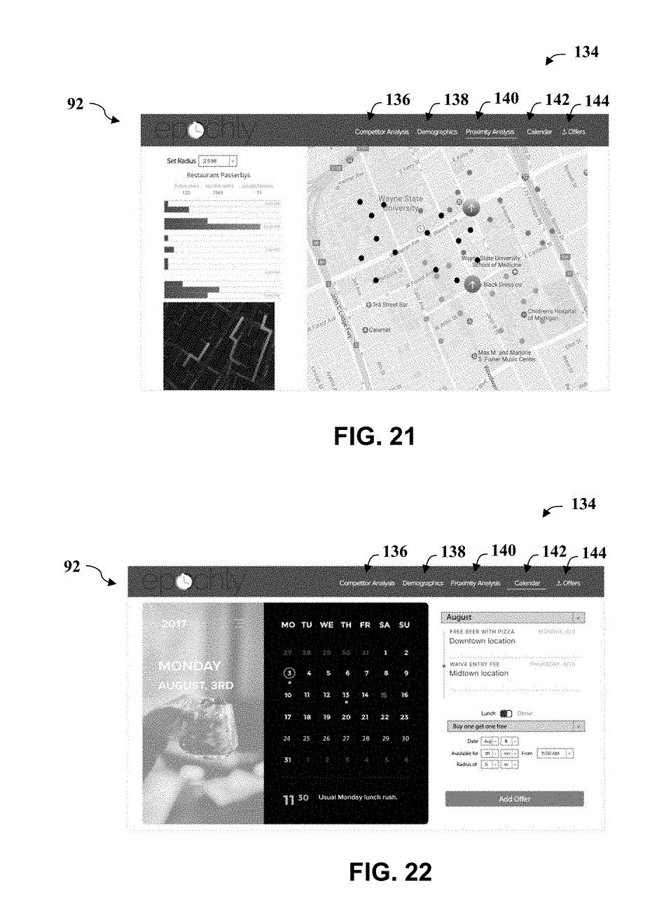

In another view, the vendor may view on the proximity tab 140, through the user computing device 14 via the website hosting server 34, the system 10 users around the vendor location, and further filter these users to include only those who either (1) frequent the vendor; or (2) frequent other vendors who sell similar products or services. In addition, the vendor may define a radius and daily statistics that may be shown, broken down by hour. The number of active system 10 users are shown, as are inactive users, and the number of similar local vendors. The user density is shown at a glance on a small street map, and in detail on a larger map that takes up most of the page (shown in FIG. 21). On the large map, the vendor in question is indicated by a large dot (with an arrow), and the other vendor is also shown as a large dot. Users that frequent a specific vendor are indicated by the same color, and users that are “up for grabs” are shown in black.

The calendar tab 142, illustrated in FIG. 22, allows for planning of offers or promotions by the vendor through the user computing device by the website hosting server 34, for premade sales campaigns and automatic sales campaigns.

The offer tab 144 facilitates easier issuing of offers for sales campaigns during peak business hours, through the sales campaign broker server 36, when the vendor does not have the time to sit and type all of the information for the sales campaign. Here, the vendor may toggle between lunch and dinner, and a drop-down menu of the most commonly-issued premade sales campaigns. The vendor may define the campaign time and radius, and through the user computing device 14 enable the application server 40 to re-issue/terminate the offer if conversion or traffic increase/decrease. This tab may also display a preview of the offer on the user computing device 14, and allow the vendor to post the sales campaign 60 to social media.

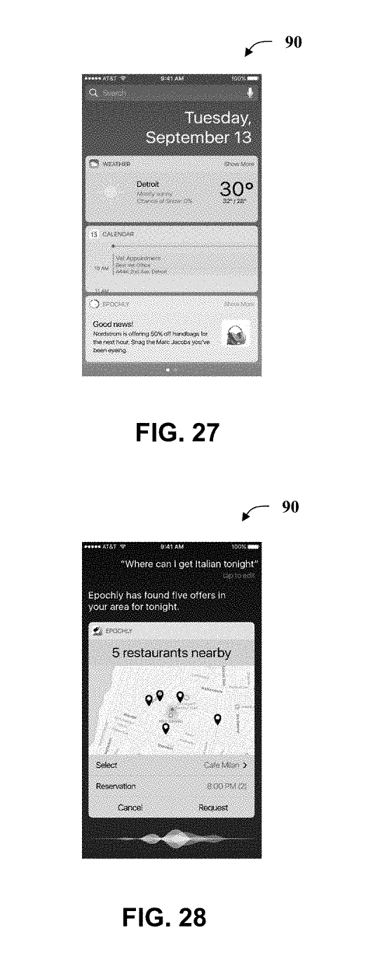

As illustrated in FIGS. 24-32, the typical consumer experience may be displayed. In FIG. 24-26, the website hosting server 34 displays a notification on the user computing device for example, a promotion like lunch at the time the user typically takes a lunch break. This interaction is shown in both screens on this page. FIG. 27 is an example of the system 10 using the user shopping history to find a promotion on an item that the user has considered purchasing. In addition FIG. 28, the system 10 may find promotions 68 for the user based on what the user specifically requests from the application server 40 at the free time slot. Once, the user decides to accept the promotion, the application server 40 may notify other users if necessary via iMessage (shown in FIG. 29). In FIG. 30, the user current feed of promotions from similar vendors is shown. The user may view on the user computing device 14 all of the promotions ar once and the user may select through the website hosting server 34 one promotion. Once the promotion has been accepted, the rejected vendors are notified and given the opportunity to counter offer to out-bid one another for the user business, as described above. In another embodiment, the user computing device may display the current promotions on a map relative to the user current location, shown in FIG. 31, and the user computing device 14 may display the directions to any particular promotion as shown in FIG. 32. In FIG. 26, the user may specify what the user preferences are for shopping and the system may ping local vendors to notify that users are currently shopping and ready to purchase if the price is right. The promotions received by the website hosting server 34 may be displayed on the user computing device 14 and more detail may be displayed once the user chooses to see more of the promotion.

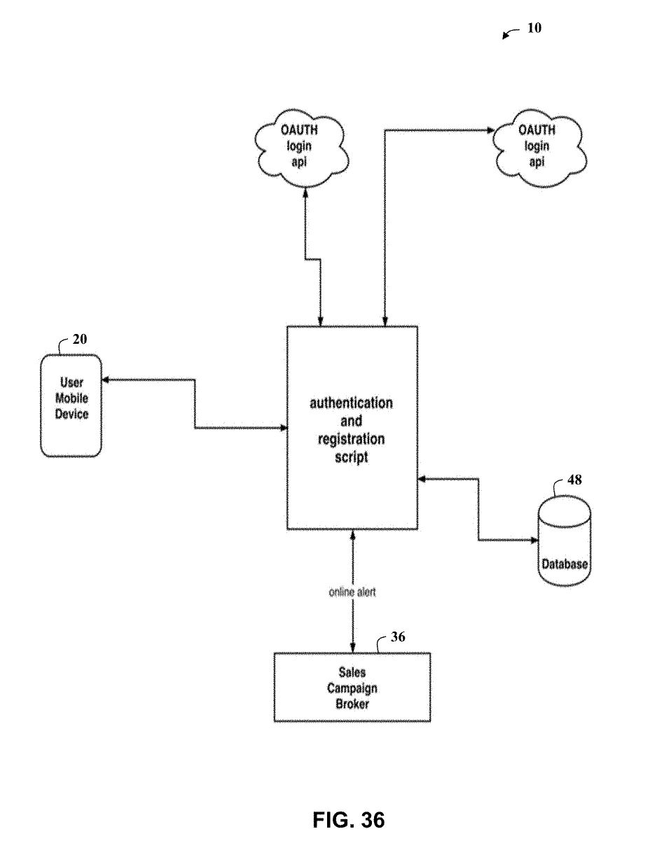

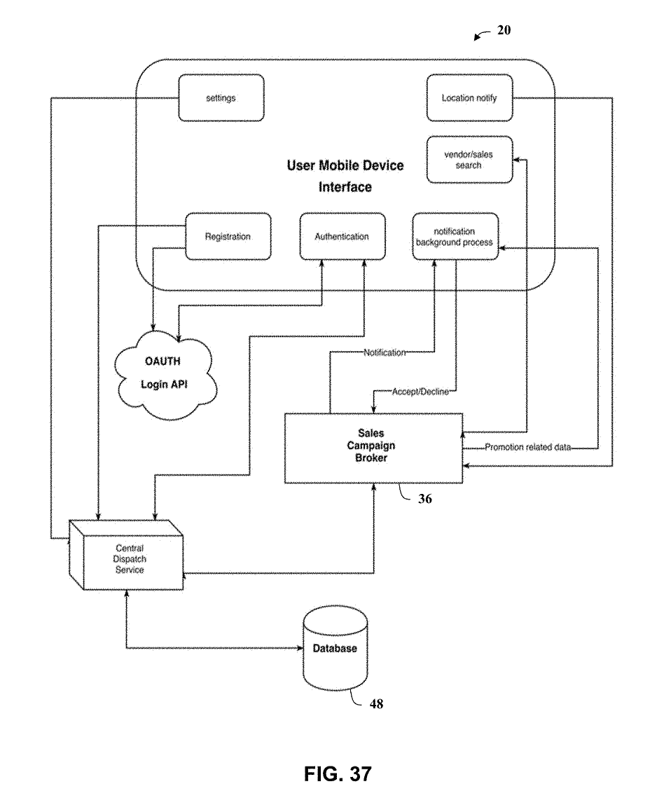

In another embodiment, shown in FIG. 36-37, after the user computing device has installed the user version of the system the user may will need to create an account via the registration screen. Using the registration screen on the mobile computing device 20 the user may submit data to create a uniquely identified account within the system. The registration script may allow manually submitted data to create accounts as well as utilizing OAuth login APIs to various social media services that may facilitate the importing of the user data from the chosen social media service. Once the account is created, the account data is stored in the database 48 for future use and identification. The authentication portion of the script may run with the system 10 by sending both online alerts and periodic location updates to the application server 40 when the mobile computing device 20 is moving. The users may have the ability to control when the external server may locate the mobile computing device 20 via a settings interface of the website hosting server 34. The authentication script may validate the user account via unique and secure login verification tokens each time the mobile computing device 20 communicates with the application server 40.

In addition, shown in FIG. 34, the website hosting server 34 on the mobile computing device 20 represents the system 10 installed on the mobile computing device 20. The user may communicate with the application server 40, and provide access to the registration and authentication process so that the user may register and create the unique account using the mobile computing device 20. Once the user has been authenticated, the user may have the ability to use the user computing device 14 to adjust settings that may define what data is sent to the system 10 including availability, location, interests, etc. If the user has allowed it the system 10 via the settings screen, the location event may periodically update the application server 40 with pertinent information about the user's location.

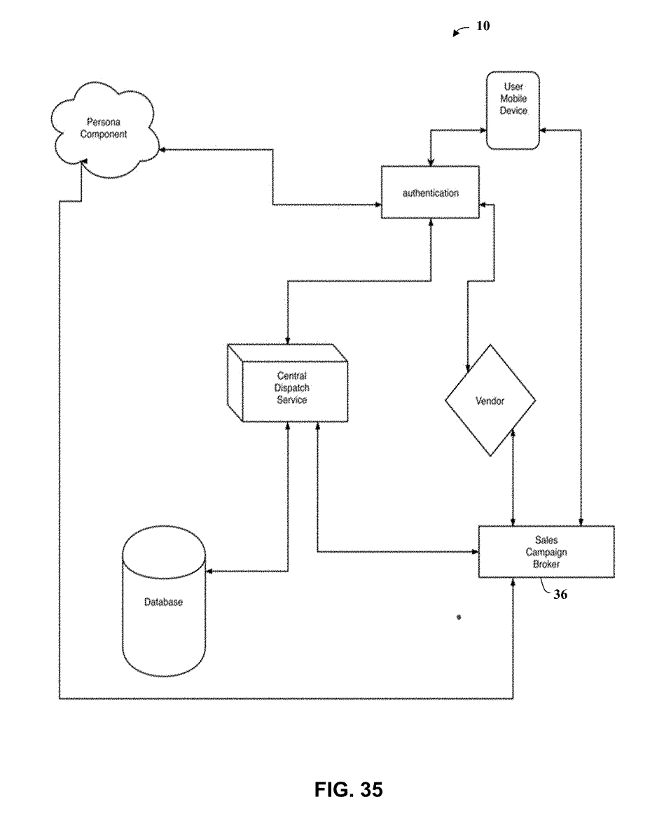

In another embodiment, shown in FIGS. 19-23, the website hosting server 34 may have an additional view for vendors. The website hosting server 34 provides the vendor with access to the system 10 where the vendor may go through the registration process to create an account that is stored in the database 48 once the vendor submits the data to the application server 40. There are two ways in which the vendor may interact with the system via the user computing device including the premade sales campaigns that are promotional offers that the vendors create in advance and store in the database 48 for activation in the future. In order to create the premade sales campaign, the vendor chooses user criteria, defines the promotional offering, optionally define supplemental data for campaigns (i.e., promo codes) and sends this information to the sales campaign broker server 36 to store. The second sales campaign is the automatic sales campaign which may be scheduled by the vendor to automatically activate at a specified date and time. Through the system 10, the vendor may initiate direct contact to users using the system 10 where the application server 40 queries the database 48 for the active user list and the vendor may filter and select individual users to send targeted promotional offers in real-time. The promotion acceptance by the user is sent via the website hosting server 34 to the application server 40 and back to the vendor computing device 14. In addition, through the system 10 the application server 40 (central dispatch service, as shown in FIG. 35) provides the vendor access to communicate with the database 48 when necessary and pertinent data associated with real-time transactions may be cached by the application server 40 for faster access.

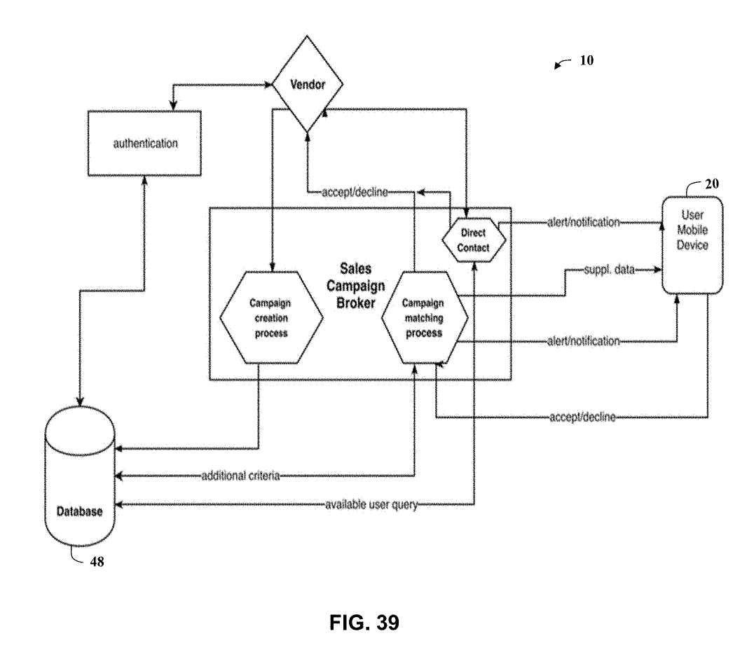

In another embodiment, as illustrated in FIG. 39, the sales campaign broker server 36 controls the communication between the user computing device 14 and the vendor. The sales campaign broker server 36 accepts input from authenticated vendors and uses the submitted data to create sales campaigns store on the database 48. The sales campaign data stored in the database 48 is used by the application server 40 (also known as the campaign matching process) to identify users that meet the campaign time (predefined parameters) set in the sales campaign 60. The application server 40 may alert users that meet the criteria set for the sales campaign by sending a message to the mobile computing device 20 which is presented to the user as a notification. These notifications can be stand-alone alerts that inform the user of open promotions available from the vendor or the notifications can be follow-up alerts that require confirmation response from the user. The follow-up alerts are sent to the user computing device 14 as notifications with the option to accept or decline the offer. The user can accept, decline or ignore a follow-up alert. If the user declines the offer a decline message may be sent back to the application server 40. If the user ignores the notification it will timeout after a predetermined time interval and a decline message is sent to the application server 40. If the user accepts the offer an accept message is sent to the application server and then supplemental data may be sent for the user to verify the acceptance (i.e. promotional code, secret password, etc.). The application server 40 may also provide vendors with a direct contact process that will allow the vendor to query the database 48 for a list of available users along with account data associated with the users. The direct contact process allows vendors to send custom offers to available users in real-time. The direct contact query process can be filtered by the vendors to better target users for real time direct offers.

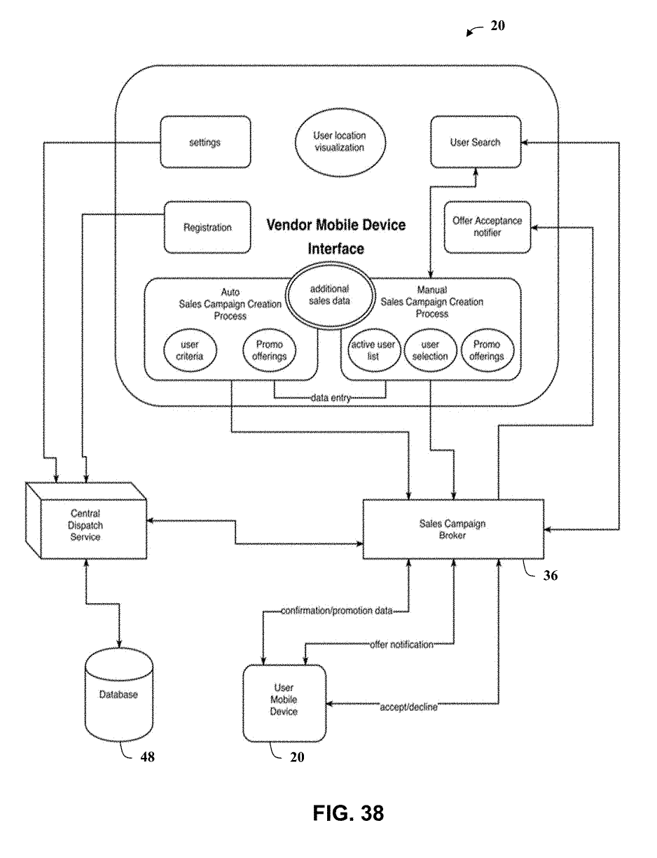

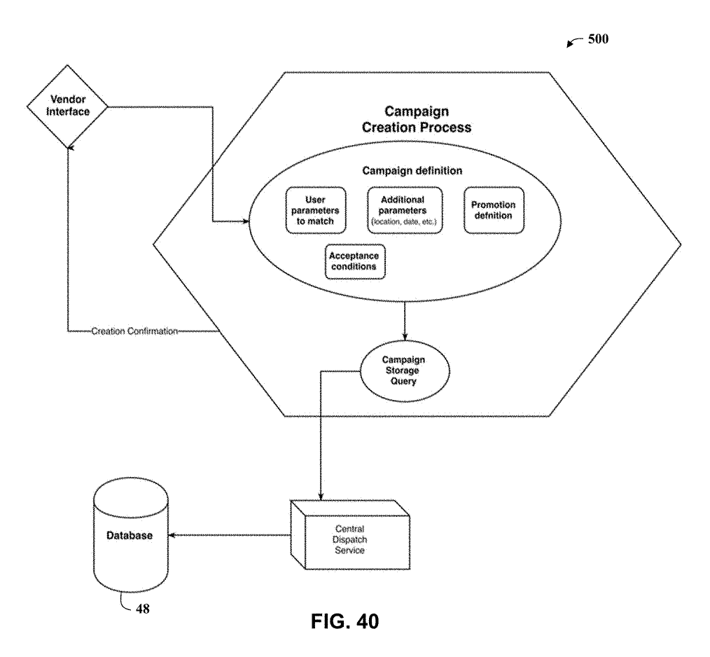

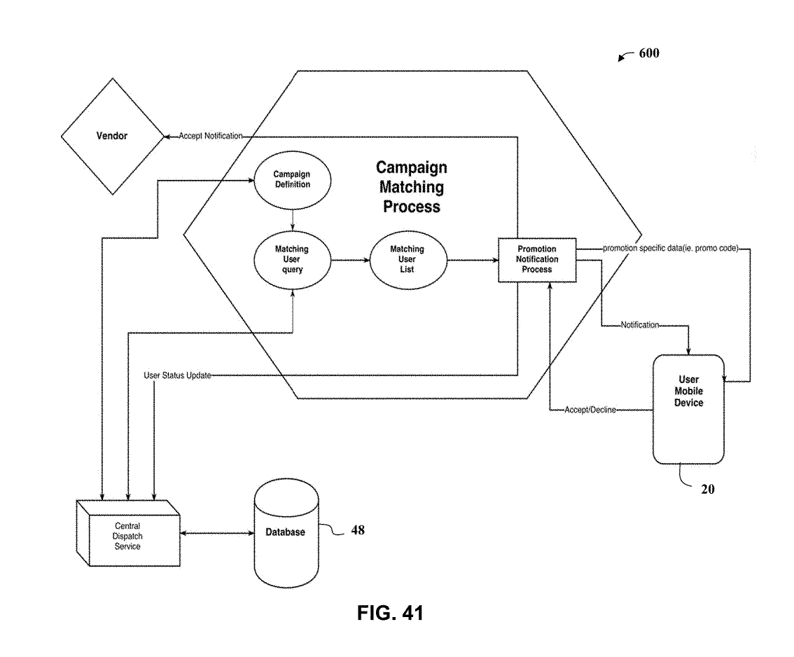

In addition, shown in FIG. 38, the system 10 may include the sales campaign broker server 36 facilitating the background process that accepts vendor input from the vendor mobile computing device 20 to create and store sales campaigns. The vendor provides user parameters and additional details to filter and target specific users. The vendor may also submit the actual promotion offering as well as additional acceptance conditions if the offer requires user follow-up. Once the vendor submits the required data elements to the sales campaign broker server 36, the data set is sent to the application server 40 to be stored in the database 48. In another embodiment, shown in FIGS. 40 and 41, the methods 500 and 600 are illustrated where the application server 40 (also known as the campaign creation process and the campaign matching process) may run constantly and query the database 48 for active sales campaigns. When the application server 40 finds active campaigns, it queries the database 48 for matching users based on the sales campaign parameters and creates a user list. The promotion notification process then issues unique notification alerts to the mobile computing devices 20 of matched users that are tracked by the token system. The application server 40 (also known as the promotion notification process) receives accept or decline messages from the users for follow-up promotion notification. The application server 40 may also send the response to follow-up promotion data upon receiving and accepting the message from the user on the mobile computing device 20. All of the records of these transactions are submitted to the database 48 for storage. These transaction records update the status of the user so that the user may not be re-targeted by the matching user query for a given sales campaign.

Overall, the vendor (business owners) may be able to view different sets of data through the user computing device 14. The data for these different data sets is acquired using the application server 40. The collection of events may be code that is constantly running on redundant cloud servers. In addition, the application server 40 may provide the data for the different presentational views for business owners by querying the database 48 for the desired data sets. When Business owners open the proximity map using the user computing device 14 the website hosting server 34 may send data requests to the application server 40 for processing and may request the data using specialized queries to retrieve the requested data from the database 48 and return the data to the business owner.

In addition, the application server 40 includes specialized software that may provide access to the data stored in the database 48 residing on a cloud server. This software may facilitate all communication with the database 48 via streamlined queries designed for efficiency. Once the vendor creates a custom sales campaign via the user computing device the data that defines the campaign is stored in the database 48. The constantly running application server 40 may watch the database 48 for active campaigns via specialized communication API. The sales campaign broker server 36 may be responsible for initiating sales campaigns by sending notification messages to the vendor that the sales campaign is active and beginning the user query cycle to search for active matched users. The user query cycle will use the application server 40 to periodically check the status, location and other parameters of active users. The application server 40 may also facilitate the database 48 connections required to provide the real-time status updates to the vendors. By utilizing network connections from the cloud server the application server 40 may also be used by the notification processes of the sales campaign broker server 36 to communicate with the user computing devices 14 when sending and receiving data on offers and acceptance/confirmation messages. The website hosting server 34 may communicate with the user computing devices 14 via the respective notification APIs. Data collected from the website hosting server 34 via web forms may be submitted to the application server 40 using the background data APIs of the website hosting server 34 and stored in the database 48. The user's location and other relevant data may be transmitted via the secure API and the external server 42 to the application server 40 using the custom notification scripts built into the background processes of the system 10 for real time data tracking.

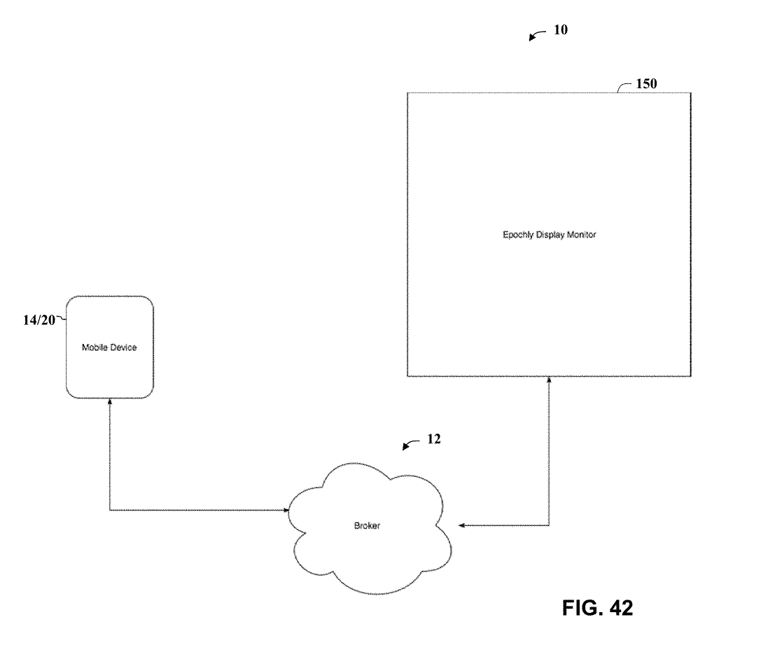

Referring to FIG. 42, in one embodiment, the system 10 includes a display monitor 150 coupled to the server system 12. The display 150 (also known as the Epochly Monitor™) is configured to run a custom version of the Debian based Linux operating system allowing for easy and continuous system upgrades as well as providing a platform for custom script development. The operating system will provide the required networking backbone to utilize real-time communication between the central brokerage service of the App and the display 150. By using custom written packet technology and incorporating nodejs servers the display 150 consistently maintains open socket communication with multiple users and the central brokerage service. Using custom optimization code the display 150 manipulates physical memory in order to cache data for future broadcast in the event of network disconnect. A manual toggle selector located on the outer edge of the display 150 will allow toggling between the different modes provided by the display including individual user detail mode, Full view mode, Collaboration mode, assignment mode, etc. The digital equivalent module of the toggle switch is displayed on the board and the user has the ability to select and move the module to a convenient location or hide it completely.

The display 150 is configured to show the current schedule and free time for all users in large overview format for a bird's eye view while reflecting real-time changes via the custom socket connections between connected users. Using the different display modes, users will be able to view task lists (scheduled and unscheduled) for single or multiple users all on one large interface. The display 150 includes a touch screen interface that allows adding and ranking unscheduled tasks as well as adding scheduled tasks via the digital keyboard, DirectType handwriting recognition, the custom symbol alphabet, or the intuitive drag and drop/copy and paste multi-touch functionality utilizing the latest touch algorithms to provide precise control. The display 150 allows the usage of a simulated, digital keyboard shown on the display with which users can type conventionally. The keyboard includes digital drag and drop notch so that users can conveniently position and resize it. By switching to the Collaboration mode, users can display multiple schedules and task lists in tandem to visualize availability and facilitate collaboration and coordination. The display 150 is configured to constantly update based on input data from connected users of the Epochly App to show scheduling changes and free time availability. The display 150 is configured to enable two way communication with authorized uses to allow cross interactions and scheduling updates between users and teams via the custom socket connections provided by the node.js server architecture.

The display 150 provides a central HUB view of all scheduling data for teams. The display 150 utilizes custom OCR recognition technology to allow users to interface with the board directly using the accompanying stylus. By incorporating the custom DirectType handwriting recognition scanning software into the surface of the board the display 150 will allow users to quickly hand write tasks that will be interpreted and recorded as if typed in. The display 150 incorporates a grid system that will allow users to provide precise guided gestures and symbols to utilize the custom command alphabet for the system.

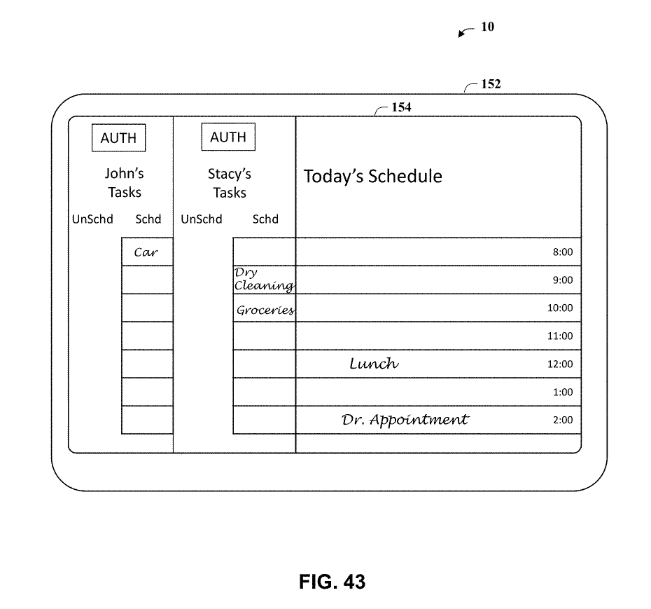

Referring to FIG. 43, in one embodiment, the system includes a physical companion board 152 with very specific dimensions that is configured to be mounted on a wall inside a user's home and/or business. The companion board 152 includes a specific grid matrix 154 printed on a surface of the board including a specific column on the board to hang post-it notes of tasks the user plans to accomplish. Other sections of the grid matrix provides areas for the user to handwrite schedule items and hang them in the appropriate day/time slot. The mobile application of the mobile computing device 20 is programmed to allow the user to take a picture of the board and transmit the image to the server system 12. The server system 12 analyses the image including information placed within predefined areas of the grid matrix 154, modify the user's schedule and task list based on the received data, and sync the modified schedule with the mobile application so the user's schedule is stored on the user's mobile device 20. For example, in one embodiment, the server system 12 may include an Optical character recognition (OCR) server. The OCR server is configured to receive the image from the mobile device 20 and analysis the received image to detect characters displayed within the predefined sections of the grid matrix 154. In one embodiment, the OCR server is programmed to preform pattern matching to compare the received image to a stored glyph on a pixel-by-pixel basis. The OCR server may also be programmed to perform feature extraction to decompose the image glyphs into features such as, for example, lines, closed loops, line direction, and line intersections, and compares the features to vector-like representations of characters.

A controller, computing device, server or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database 48, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database 48 may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A computer system, comprising:
a database including a plurality of sales campaign data records and a plurality of user records;
wherein each sales campaign data record is associated with a retail product offering and includes a unique vendor ID associated with a vendor, address data indicating a physical location of the vendor, and promotion data including a campaign time period, a service time, and product offering information, the campaign time period including a period of time during which the retail product offering is available to consumers, the service time including an amount of time required to provide the retail product offering to a consumer;
wherein each user record includes a unique user ID associated with a corresponding consumer, a mobile ID associated with a mobile computing device, data associated with a plurality of calendar events, each calendar event including a calendar time period and location, the plurality of calendar events including a first appointment event, a second appointment event, and a free time slot between the first appointment and the second appointment; and
an application server including a processor programmed to:
select a current sales campaign from the plurality of sales campaigns and initiate the current sales campaign including:
determine a current campaign time period, a current service time, and a current vendor location associated with the current sales campaign;
identify qualified consumers associated with the selected current sales campaign including:
identify user records having free time slots that are within the current campaign time period and, for each identified user record:
determine a current location of a mobile computing device associated with the identified user record;
determine a first travel time from the current location to the current vendor location;
determine a second travel time from the current vendor location to the second appointment event; and
determine a total event time period equal to the first travel time, the second travel time, and the service time; and
generate a set of qualified consumers including each identified user record having a determined total event time period within a corresponding free time slot; and
transmit a notification including a first promotion including product offering information associated with the selected sales campaign to each mobile computing device associated with each qualified consumer.

2. The system of claim 1, wherein the application server is further configured to:
select a second sales campaign having a campaign time period that is similar to the current campaign time period; and
identify a second set of qualified consumers associated with the second sales campaign;
transmit a second notification including a second promotion including product offering information associated with the second sales campaign to each mobile computing device associated with each qualified consumer in the second set of qualified consumers, wherein the second promotion is transmitted at the same time as the first promotion; and
receive a response from each qualified consumer via a corresponding mobile computing device indicating a selection by the consumer of one of the first and second promotions.

3. The system of claim 1, wherein the first sales campaign is associated with a first vendor and the second sales campaign is associated with a different vendor.

4. The system of claim 1, wherein the application server is further configured to
receive a campaign start request from a vendor via a user computing device including a vendor submitted sales campaign;
identify qualified consumers associated with the vendor submitted sales campaign upon receiving the campaign start request; and
transmit a promotion notification to each identified qualified consumer associated with the vendor submitted sales campaign, the promotion notification including information associated with the vendor submitted sales campaign.

5. The system of claim 1, wherein each sales campaign data record includes a trigger condition, the application server is programmed to initiate the selected sales campaign upon detecting corresponding trigger condition associated with the selected sales campaign.

6. The system of claim 5, wherein the trigger condition includes a predefined campaign start-time, the application server is programmed to detect a trigger condition when a current time is equal to the predefined campaign start-time.

7. The system of claim 1, wherein the application server is programmed to periodically update the set of qualified consumers during the current campaign time period.

8. The system of claim 1, wherein the application server is further configured to:
generate and transmit a message to a first consumer included in the set of qualified consumers including information indicated that a second consumer included in the set of qualified consumers received the promotion from the vendor; and
receive a request from the first consumer to transmit an invitation message and responsively transmit the invitation message to the second consumer, the invitation message including an invitation to meet at the vendor location associated with the promotion.

9. A method comprising:
accessing a database including a plurality of sales campaign data records, wherein each sales campaign data record is associated with a retail product offering and includes a unique vendor ID associated with a vendor, address data indicating a physical location of the vendor, and promotion data including a campaign time period, a service time, and product offering information, the campaign time period including a period of time during which the retail product offering is available to consumers, the service time including an amount of time required to provide the retail product offering to a consumer;
selecting a current sales campaign from the plurality of sales campaigns and initiating the current sales campaign including:
determining a current campaign time period, a current service time, and a current vendor location associated with the current sales campaign;
identifying qualified consumers associated with the selected current sales campaign including:
accessing the database including a plurality of user records, wherein each user record includes a unique user ID associated with a corresponding consumer, a mobile ID associated with a mobile computing device, data associated with a plurality of calendar events, each calendar event including a calendar time period and location, the plurality of calendar events including a first appointment event, a second appointment event, and a free time slot between the first appointment event and the second appointment event;
identifying user records having free time slots that are within the current campaign time period and, for each identified user record:
determining a current location of a mobile computing device associated with the identified user record;
determining a first travel time from the current location to the current vendor location;
determining a second travel time from the current vendor location to the second appointment event; and
determining a total event time period equal to the first travel time, the second travel time, and the service time; and
generating a set of qualified consumers including each identified user record having a determined total event time period within a corresponding free time slot; and
transmitting a notification including a first promotion including product offering information associated with the selected sales campaign to each mobile computing device associated with each qualified consumer.

10. A method in accordance with claim 9, further comprising:
selecting a second sales campaign having a campaign time period that is similar to the current campaign time period; and
identifying a second set of qualified consumers associated with the second sales campaign;
transmitting a second notification including a second promotion including product offering information associated with the second sales campaign to each mobile computing device associated with each qualified consumer in the second set of qualified consumers, wherein the second promotion is transmitted at the same time as the first promotion; and
receiving a response from each qualified consumer via a corresponding mobile computing device indicating a selection by the consumer of one of the first and second promotions.

11. A method in accordance with claim 9, wherein the first sales campaign is associated with a first vendor and the second sales campaign is associated with a different vendor.

12. A method in accordance with claim 9, further comprising:
receiving a campaign start request from a vendor via a user computing device including a vendor submitted sales campaign;
identifying qualified consumers associated with the vendor submitted sales campaign upon receiving the campaign start request; and
transmitting a promotion notification to each identified qualified consumer associated with the vendor submitted sales campaign, the promotion notification including information associated with the vendor submitted sales campaign.

13. A method in accordance with claim 9, wherein each sales campaign data record includes a trigger condition, the application server is programmed to initiate the selected sales campaign upon detecting corresponding trigger condition associated with the selected sales campaign.

14. A method in accordance with claim 9, wherein the trigger condition includes a predefined campaign start-time, the application server is programmed to detect a trigger condition when a current time is equal to the predefined campaign start-time.

15. A method in accordance with claim 9, wherein the application server is programmed to periodically update the set of qualified consumers during the current campaign time period.

16. A method in accordance with claim 9, further comprising:
generating and transmit a message to a first consumer included in the set of qualified consumers including information indicated that a second consumer included in the set of qualified consumers received the promotion from the vendor; and
receiving a request from the first consumer to transmit an invitation message and responsively transmit the invitation message to the second consumer, the invitation message including an invitation to meet at the vendor location associated with the promotion.

17. One or more non-transitory computer-readable storage media, having computer executable instructions embodied thereon, wherein when executed by at least one processor, the computer-executable instructions cause the processor to:
access a database including a plurality of sales campaign data records and a plurality of user records;
wherein each sales campaign data record is associated with a retail product offering and includes a unique vendor ID associated with a vendor, address data indicating a physical location of the vendor, and promotion data including a campaign time period, a service time, and product offering information, the campaign time period including a period of time during which the retail product offering is available to consumers, the service time including an amount of time required to provide the retail product offering to a consumer;
wherein each user record includes a unique user ID associated with a corresponding consumer, a mobile ID associated with a mobile computing device, data associated with a plurality of calendar events, each calendar event including a calendar time period and location, the plurality of calendar events including a first appointment event, a second appointment event, and a free time slot between the first appointment event and the second appointment event; and
select a current sales campaign from the plurality of sales campaigns and initiate the current sales campaign including:
determine a current campaign time period, a current service time, and a current vendor location associated with the current sales campaign;
identify qualified consumers associated with the selected current sales campaign including:
identify user records having free time slots that are within the current campaign time period and, for each identified user record:
determine a current location of a mobile computing device associated with the identified user record;
determine a first travel time from the current location to the current vendor location;
determine a second travel time from the current vendor location to the second appointment event; and
determine a total event time period equal to the first travel time, the second travel time, and the service time; and
generate a set of qualified consumers including each identified user record having a determined total event time period within a corresponding free time slot; and
transmit a notification including a first promotion including product offering information associated with the selected sales campaign to each mobile computing device associated with each qualified consumer.

18. One or more non-transitory computer-readable storage media in accordance with claim 17, wherein the computer executable instructions cause the processor to:
select a second sales campaign having a campaign time period that is similar to the current campaign time period; and
identify a second set of qualified consumers associated with the second sales campaign;
transmit a second notification including a second promotion including product offering information associated with the second sales campaign to each mobile computing device associated with each qualified consumer in the second set of qualified consumers, wherein the second promotion is transmitted at the same time as the first promotion; and
receive a response from each qualified consumer via a corresponding mobile computing device indicating a selection by the consumer of one of the first and second promotions.

19. One or more non-transitory computer-readable storage media in accordance with claim 17, wherein the computer executable instructions cause the processor to:
receive a campaign start request from a vendor via a user computing device including a vendor submitted sales campaign;
identify qualified consumers associated with the vendor submitted sales campaign upon receiving the campaign start request; and
transmit a promotion notification to each identified qualified consumer associated with the vendor submitted sales campaign, the promotion notification including information associated with the vendor submitted sales campaign.

20. One or more non-transitory computer-readable storage media in accordance with claim 17, wherein the computer executable instructions cause the processor to:
generate and transmit a message to a first consumer included in the set of qualified consumers including information indicated that a second consumer included in the set of qualified consumers received the promotion from the vendor; and
receive a request from the first consumer to transmit an invitation message and responsively transmit the invitation message to the second consumer, the invitation message including an invitation to meet at the vendor location associated with the promotion.
